(19) United States
(12) Patent Application Publication
(10) Pub. No.: US 2026/0231295 A1
(43) Pub. Date: Aug. 6, 2026

(54) MOISTURE REMOVAL SYSTEM, MOISTURE REMOVAL METHOD, AND PROGRAM

(71) Applicant: Panasonic Intellectual Property Management Co., Ltd., Kadoma-shi, Osaka (JP)

(72) Inventors: Takuto Abe, Osaka (JP); Masaki Sawada, Osaka (JP); Hiroaki Nishiono, Osaka (JP); Kota Araki, Kanagawa (JP)

(73) Assignee: Panasonic Intellectual Property Management Co., Ltd., Kadoma-shi, Osaka (JP)

(21) Appl. No.: 19/148,119

(22) PCT Filed: Jan. 23, 2024
(86) PCT No.: PCT/JP2024/001751

§ 371 Date: Jul. 15, 2025

(30) Foreign Application Priority Data
Jan. 23, 2023 (JP) 2023-008405

(51) Int. Cl. H05B 1/02; G01D 5/24; G01N 27/22; G02C 11/08; H05B 3/03; H05B 3/26

(52) U.S. Cl. CPC H05B 1/0208; G01D 5/24; G01N 27/223; H05B 3/03; H05B 3/26; G02C 11/08; H05B 2203/005; H05B 2203/013

(57) ABSTRACT

In a moisture removal system of the present disclosure, a base member has a first transmission part capable of transmitting an electromagnetic wave. A first electrode has a second transmission part capable of transmitting the electromagnetic wave and is disposed on the base member such that the second transmission part overlaps the first transmission part. A second electrode has a third transmission part capable of transmitting the electromagnetic wave and is disposed on the base member such that the third transmission part overlaps the first transmission part. A control circuit performs first operation of detecting capacitance between the first electrode and the second electrode and second operation of energizing at least one electrode of the first electrode or the second electrode to generate Joule heat at the at least one electrode.

### DESCRIPTION

### Technical Field

The present disclosure generally relates to moisture removal systems, moisture removal methods, and programs and more specifically relates to a moisture removal system configured to be attached to an object to remove adhering moisture, a moisture removal method, and a program.

### Background Art

Patent Literature 1 describes a solar cell module including a solar cell element and a heater film. The heater film has an electrode formed on a base sheet. The electrode functions as a capacitive detection electrode to detect accumulated snow on a surface of the solar cell module and also functions as a heating electrode to melt the accumulated snow. In the solar cell module described in Patent Literature 1, detecting the change in floating capacitance between the heater film and the solar cell element allows detection of presence or absence of snow adhesion.

In the solar cell module described in Patent Literature 1, however, to detect the floating capacitance between the heater film (a moisture removal system) and the solar cell element (an object), capacitive coupling has to be formed between the heater film and the solar cell element.

### CITATION LIST

### Patent Literature

Patent Literature 1: JP 2020-181726 A

### SUMMARY OF INVENTION

It is an object of the present disclosure to provide a moisture removal system, a moisture removal method, and a program which are configured to detect and remove adhering moisture without forming capacitive coupling to a portion other than a heater film.

A moisture removal system according to an aspect of the present disclosure is a moisture removal system configured to be attached to an object to remove adhering moisture. The moisture removal system includes a base member which is electrically insulating, a first electrode, a second electrode, and a control circuit. The base member has a first transmission part capable of transmitting an electromagnetic wave. The first electrode has a second transmission part capable of transmitting the electromagnetic wave and is disposed on the base member such that the second transmission part overlaps the first transmission part. The second electrode has a third transmission part capable of transmitting the electromagnetic wave and is disposed on the base member such that the third transmission part overlaps the first transmission part. The control circuit is connected to the first electrode and the second electrode. The control circuit is configured to perform first operation and second operation. The first operation is operation of detecting capacitance between the first electrode and the second electrode. The second operation is operation of energizing at least one electrode of the first electrode or the second electrode to generate Joule heat at the at least one electrode.

A moisture removal method used for a moisture removal system which includes a base member having an electrically insulating property, a first electrode, a second electrode, and a control circuit and which is to be attached to an object to remove adhering moisture. The base member has a first transmission part configured to be attached to the object and capable of transmitting an electromagnetic wave. The first electrode has a second transmission part capable of transmitting the electromagnetic wave and is disposed on the base member such that the second transmission part overlaps the first transmission part. The second electrode has a third transmission part capable of transmitting the electromagnetic wave and is disposed on the base member such that the third transmission part overlaps the first transmission part. The control circuit is connected to the first electrode and the second electrode. The moisture removal method includes a first step and a second step. The first step is a step of detecting capacitance between the first electrode and the second electrode by the control circuit. The second step is a step of energizing at least one electrode of the first electrode or the second electrode by the control circuit to generate Joule heat at the at least one electrode.

A program according to an aspect of the present disclosure is a program configured to cause one or more processors to execute the moisture removal method.

### BRIEF DESCRIPTION OF DRAWINGS

FIG. 1 is a perspective view of an application example of a moisture removal system according to a first embodiment;

FIG. 2 is a perspective view of the moisture removal system;

FIG. 3 is an exploded perspective view of the moisture removal system;

FIG. 4 is a circuit diagram illustrating first operation of a control circuit of the moisture removal system;

FIG. 5 is a circuit diagram illustrating second operation of the control circuit of the moisture removal system;

FIG. 6 is a flowchart of a moisture removal method according to the first embodiment;

FIG. 7 is a circuit diagram illustrating the first operation of a control circuit of a moisture removal system according to a first variation of the first embodiment;

FIG. 8 is a circuit diagram illustrating the second operation of the control circuit of the moisture removal system according to the first variation;

FIG. 9 is a perspective view of an application example of a moisture removal system according to a second embodiment;

FIG. 10 is an exploded perspective view of the moisture removal system according to the second embodiment;

FIG. 11 is a circuit diagram illustrating the first operation of a control circuit of the moisture removal system according to the second embodiment;

FIG. 12 is a circuit diagram illustrating the second operation of the control circuit of the moisture removal system according to the second embodiment;

FIG. 13 is a perspective view of an application example of a moisture removal system according to a third embodiment;

FIG. 14 is an exploded perspective view of an application example of a moisture removal system according to a fourth embodiment;

FIG. 15 is an exploded perspective view of the moisture removal system according to the fourth embodiment;

FIG. 16 is a partially enlarged view of a first electrode and a second electrode of the moisture removal system according to the fourth embodiment;

FIG. 17 is a partially enlarged view of a first electrode and a second electrode of a moisture removal system according to a first variation of the fourth embodiment;

FIG. 18 is a partially enlarged view of a first electrode and a second electrode of a moisture removal system according to a second variation of the fourth embodiment;

FIG. 19 is a perspective view of an application example of a moisture removal system according to a fifth embodiment; and

FIG. 20 is an exploded perspective view of the application example of the moisture removal system according to the fifth embodiment.

### DESCRIPTION OF EMBODIMENTS

A moisture removal system, a moisture removal method, and a program according to each of first to fifth embodiments will be described below with reference to the drawings. Figures to be referred to in the following description of the first to fifth embodiments are schematic representations. Thus, the sizes, thicknesses, and other attributes of the respective constituent elements illustrated on those drawings are not always to scale, compared with actual ones. Moreover, the configurations described in the first to fifth embodiments described below are mere examples of the present disclosure. The present disclosure is not limited to the first to fifth embodiments described below, and various modifications may be made to the first to fifth embodiments depending on design and the like as long as the effect of the present disclosure is obtained.

### First Embodiment

### (1) Overview

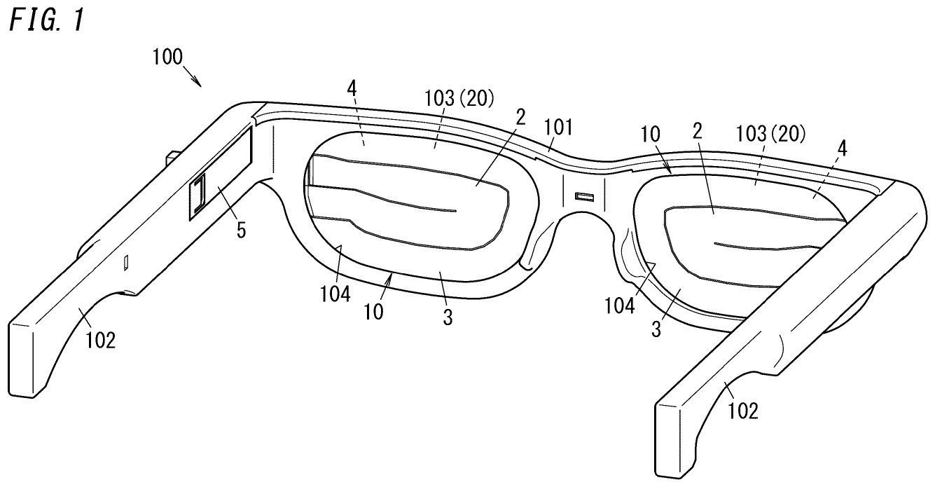

First of all, an overview of a moisture removal system 10 according to a first embodiment will be described with reference to FIGS. 1 to 3.

The moisture removal system 10 according to the first embodiment is a system configured to be attached to, for example, an object 20 to remove adhering moisture. The “moisture” includes water droplets, damp, snow, and the like. In the first embodiment, the moisture removal system 10 is a moisture removal device integrally attached to a pair of glasses 100 including the object 20. As used in the present disclosure, the “object” means a part from which moisture should be removed, but does not mean a part as a target of capacitive coupling. The object 20 is, for example, a lens 103 of the pair of glasses 100. The lens 103 is capable of transmitting, for example, visible light ranging from 405 to 790 THz. That is, the lens 103 (object 20) is capable of transmitting an electromagnetic wave at a specific frequency. In the first embodiment, the pair of glasses 100 includes a pair of lenses 103, and to each lens 103, a moisture removal system 10 is attached (see FIG. 1). That is, in the first embodiment, two moisture removal systems 10 are used.

As shown in FIGS. 1 to 3, each moisture removal system 10 according to the first embodiment includes a base member 1 having an electrically insulating property, a first electrode 2, a second electrode 3, and a control circuit 5. The base member 1 has a first transmission part 11 capable of transmitting the electromagnetic wave. The first electrode 2 has a second transmission part 21 capable of transmitting the electromagnetic wave and is disposed on the base member 1 such that the second transmission part 21 overlaps the first transmission part 11. The second electrode 3 has a third transmission part 31 capable of transmitting the electromagnetic wave and is disposed on the base member 1 such that the third transmission part 31 overlaps the first transmission part 11. The control circuit 5 is connected to the first electrode 2 and the second electrode 3. The control circuit 5 performs first operation and second operation. The first operation is operation of detecting capacitance between the first electrode 2 and the second electrode 3. The second operation is operation of energizing at least one electrode of the first electrode 2 or the second electrode 3 to generate Joule heat at the at least one electrode.

In each moisture removal system 10 according to the first embodiment, the control circuit 5 detects the capacitance between the first electrode 2 and the second electrode 3 in the first operation. Therefore, in each moisture removal system 10 according to the first embodiment, capacitive coupling to a portion which includes the object 20 and which is other than the moisture removal system 10 does not have to be formed. Moreover, in each moisture removal system 10 according to the first embodiment, the control circuit 5 generates Joule heat at at least one of the first electrode 2 or the second electrode 3 in the second operation. Therefore, in each moisture removal system 10 according to the first embodiment, the object 20 can be heated, and as a result, moisture adhering to the object 20 can be removed. That is, each moisture removal system 10 according to the first embodiment enables moisture to be detected without forming the capacitive coupling to the portion other than the moisture removal system 10 and enables the moisture adhering to the object 20, including the moisture removal system 10, to be removed.

### (2) Details

Next, the configuration of the moisture removal systems 10 according to the first embodiment will be described with reference to FIGS. 1 to 5.

As shown in FIG. 1, the moisture removal systems 10 are integrally attached to the pair of glasses 100 including the lenses 103 as objects 20. The pair of glasses 100 includes a frame 101, a pair of arms 102 and 102, and the pair of lenses 103. The frame 101 has a pair of openings 104. The pair of openings 104 are aligned in a longitudinal direction (left/right direction in FIG. 1) of the frame 101. The pair of openings 104 correspond to the pair of lenses 103 on a one-to-one basis. Each of the pair of lenses 103 is fitted in a corresponding one of the pair of openings 104. The pair of arms 102 are each foldably attached to a corresponding one of both ends in the longitudinal direction of the frame 101. Each of the pair of lenses 103 is capable of transmitting an electromagnetic wave at a specific frequency. More specifically, each of the pair of lenses 103 is capable of transmitting, for example, visible light ranging from 405 to 790 THz.

In the first embodiment, the pair of glasses 100 includes the pair of lenses 103, and to each lens 103, the moisture removal system 10 is attached. That is, in the first embodiment, two moisture removal systems 10 are used. Note that the configurations of the two moisture removal systems 10 are the same, and therefore, one (on the right side in FIG. 1) of the moisture removal systems 10 will be explained in the following description.

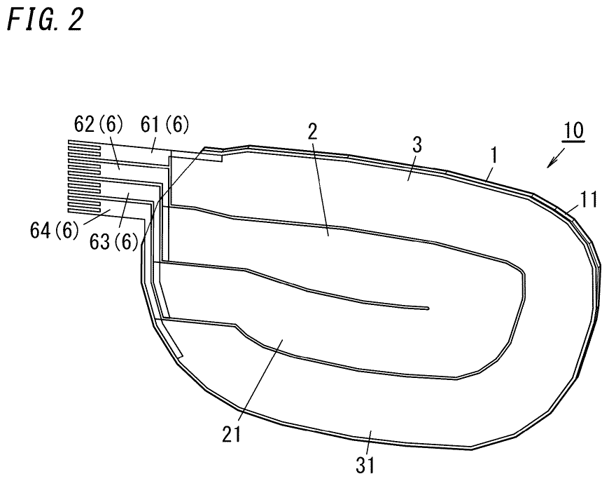

As shown in FIGS. 2 to 5, the moisture removal system 10 includes the base member 1, the first electrode 2, the second electrode 3, a protective layer 4, the control circuit 5, and a plurality of (in FIG. 2, four) connection terminals 6.

### (2.1) Base Member

The base member 1 is electrically insulating. The base member 1 is, for example, a transparent film. A material for the film is, for example, polyethylene terephthalate, polycarbonate, polyimide, polyamide, polyurethane, PMMA, polyethylene, polypropylene, polyethylene naphthalate, cyclo olefin polymer (COP), or film glass. The base member I has, for example, an elliptical shape in plan view from a thickness direction defined with respect to the base member 1 and has a substantially same size as the lens 103.

The base member 1 has the first transmission part 11 capable of transmitting an electromagnetic wave at a specific frequency. The electromagnetic wave at the specific frequency is, for example, visible light ranging from 405 to 790 THz as described above. Moreover, the base member 1 is a transparent film as described above. Therefore, in the first embodiment, the entirety of the base member 1 is the first transmission part 11.

### (2.2) First Electrode

The first electrode 2 includes, for example, indium tin oxide (ITO). The first electrode 2 has, for example, a U-shape in plan view in a thickness direction defined with respect to the first electrode 2 as shown in FIGS. 1 to 3.

The first electrode 2 has the second transmission part 21 capable of transmitting the electromagnetic wave at the specific frequency. The electromagnetic wave at the specific frequency is, for example, visible light ranging from 405 to 790 THz as described above. Moreover, the first electrode 2 includes indium tin oxide as described above. Therefore, in the first embodiment, the entirety of the first electrode 2 is the second transmission part 21. As shown in FIG. 2, the first electrode 2 is disposed on the base member 1 such that the second transmission part 21 overlaps the first transmission part 11. In the present disclosure, saying that “the first electrode is disposed on the base member” includes both the case where the first electrode is directly or indirectly disposed on a surface of the base member and the case where the first electrode is disposed in a groove formed in the surface of the base member,

### (2.3) Second Electrode

The second electrode 3 includes, for example, indium tin oxide in a similar manner to the first electrode 2. As shown in FIGS. 1 to 3, the second electrode 3 has, for example, a U-shape in plan view in a thickness direction defined with respect to the second electrode 3. Moreover, the second electrode 3 is disposed on the base member 1 such that the second electrode 3 surrounds the first electrode 2.

The second electrode 3 has the third transmission part 31 capable of transmitting the electromagnetic wave at the specific frequency. The electromagnetic wave at the specific frequency is, for example, visible light ranging from 405 to 790 THz as described above. Moreover, the first electrode 2 includes indium tin oxide as described above. Therefore, in the first embodiment, the entirety of the second electrode 3 is the third transmission part 31. As shown in FIG. 2, the second electrode 3 is disposed on the base member I such that the third transmission part 31 overlaps the first transmission part 11.

### (2.4) Protective Layer

The protective layer 4 is, for example, an optically clear adhesive (OCA). The protective layer 4 is electrically insulating. The protective layer 4 has, for example, an elliptical shape in plan view in a thickness direction defined with respect to the protective layer 4 and has a substantially same size as the base member 1. The protective layer 4 has a thickness of, for example, 0.1 mm.

The protective layer 4 has a fourth transmission part 41 capable of transmitting the electromagnetic wave at the specific frequency. The electromagnetic wave at the specific frequency is, for example, visible light ranging from 405 to 790 THz as described above. Moreover, the protective layer 4 is an OCA as described above. Therefore, in the first embodiment, the entirety of the protective layer 4 is the fourth transmission part 41. The protective layer 4 covers the first electrode 2 such that the fourth transmission part 41 overlaps the second transmission part 21. Moreover, the protective layer 4 covers the second electrode 3 such that the fourth transmission part 41 overlaps the third transmission part 31.

### (2.5) Control Circuit

The control circuit 5 includes, for example, a computer system as a main component, and the computer system includes one or more processors and one or more memory elements. In the moisture removal system 10, the one or more processors executes a program(s) stored in the one or more memory elements, thereby implementing a function as the control circuit 5. The program(s) may be stored in the one or more memory elements in advance, may be provided over a telecommunications network such as the Internet, or may be provided as a non-transitory recording medium, such as a memory card, in which the program(s) has been stored.

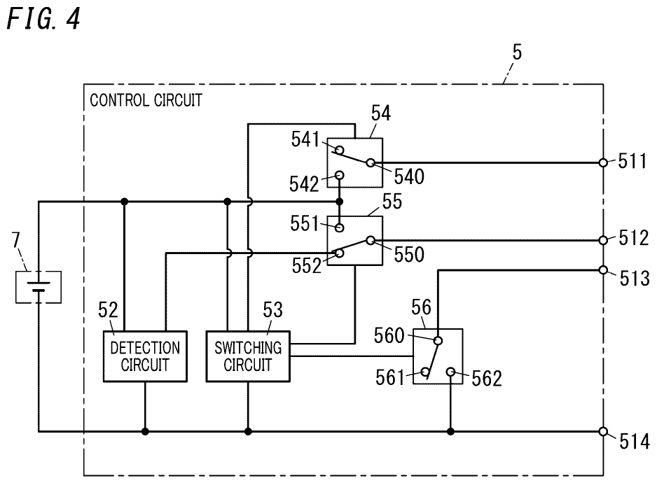

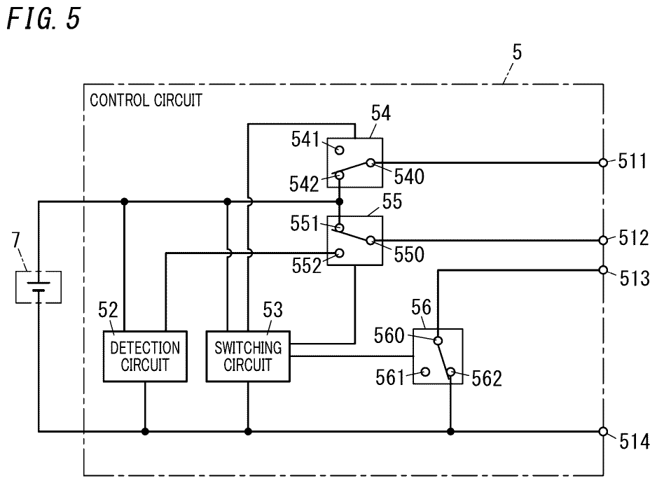

As shown in FIGS. 4 and 5, the control circuit 5 includes a plurality of (in the example shown in the figure, four) connection terminals 511 to 514, a detection circuit 52, a switching circuit 53, a first switch 54, a second switch 55, and a third switch 56. The control circuit 5 performs the first operation and the second operation, which will be described later, by using direct-current power supplied from a direct-current power supply 7. The direct-current power supply 7 is, for example, a battery. The battery is, for example, a primary battery (e.g., a lithium battery) or a secondary battery (e.g., a lithium ion battery).

The connection terminal 511 is connected to a first connection terminal 61 which will be described later. Moreover, the connection terminal 511 is connected to a common terminal 540 of the first switch 54. The common terminal 540 will be described later. The connection terminal 512 is connected to a second connection terminal 62 which will be described later. Moreover, the connection terminal 512 is connected to a common terminal 550 of the second switch 55. The common terminal 550 will be described later. The connection terminal 513 is connected to a third connection terminal 63 which will be described later. Moreover, the connection terminal 513 is connected to a common terminal 560 of the third switch 56. The common terminal 560 will be described later. The connection terminal 514 is connected to a fourth connection terminal 64 which will be described later. Moreover, the connection terminal 514 is connected to a negative-side output terminal of the direct-current power supply 7.

The detection circuit 52 detects capacitance between the first electrode 2 and the second electrode 3. That is, the control circuit 5 performs the first operation of detecting the capacitance between the first electrode 2 and the second electrode 3. The detection circuit 52 applies a detection voltage between the first electrode 2 and the second electrode 3 in the first operation. More specifically, the detection circuit 52 (the control circuit 5) applies the detection voltage between the first electrode 2 and the second electrode 3 in the first operation such that the first electrode 2 has a first potential and the second electrode 3 has a second potential. The second potential is lower than the first potential. In the first embodiment, the second potential is, for example, a ground potential. In the first embodiment, a detection method by the detection circuit 52 is a self method. The detection circuit 52 detects the capacitance between the first electrode 2 and the second electrode 3 (ground).

The switching circuit 53 switches a connection state of the first switch 54, the second switch 55, and the third switch 56 which will be described later. When the switching circuit 53 switches the connection state of the first switch 54, the second switch 55, and the third switch 56 to a state shown in FIG. 4, the control circuit 5 performs the first operation described above. When the switching circuit 53 switches the connection state of the first switch 54, the second switch 55, and the third switch 56 to a state shown in FIG. 5, the control circuit 5 performs the second operation. The second operation is operation of energizing at least one electrode of the first electrode 2 or the second electrode 3 to generate Joule heat at the at least one electrode. In the first embodiment, the control circuit 5 energizes both the first electrode 2 and the second electrode 3 in the second operation, thereby generating Joule heat at both the first electrode 2 and the second electrode 3. When an amount of change in the capacitance detected in the first operation is greater than or equal to a prescribed value, the control circuit 5 switches the connection state of the first switch 54, the second switch 55, and the third switch 56 by the switching circuit 53 and performs the second operation described above.

In this embodiment, the control circuit 5 preferably detects first capacitance and second capacitance in the first operation and compares the first capacitance and the second capacitance thus detected with each other. Then, the control circuit 5 preferably performs the second operation in accordance with a result of the comparison of the first capacitance and the second capacitance with each other. The first capacitance is capacitance detected when the a first detection voltage is applied between the first electrode 2 and the second electrode 3 such that the first electrode 2 has the first potential and the second electrode 3 has the second potential. The second potential is lower than the first potential as described above and is, for example, a ground potential. The second capacitance is capacitance detected when a second detection voltage is applied between the first electrode 2 and the second electrode 3 such that the first electrode 2 has the first potential and the second electrode 3 has a third potential. The third potential is desirably greater than or equal to the first potential, and is, for example, equal to the first potential. That is, in this case, the first electrode 2 and the second electrode 3 have the same potential. In sum, the third potential has a value greater than the second potential and is a potential difference providing a capacitance difference which enables a first capacitance value attributed to moisture and a second capacitance value attributed to contact of part (e.g., a finger) of a human body to be distinguished from each other.

For example, when a finger or the like of a user of the pair of glasses 100 is in contact with the lens 103, the first capacitance and the second capacitance have a substantially same value. In contrast, when moisture is on the lens 103, a difference greater than or equal to a specified value is caused between the first capacitance and the second capacitance. Thus, if the first capacitance and the second capacitance are equal to each other, the control circuit 5 determines that a finger or the like be in contact with the lens 103, and the control circuit 5 do not perform the second operation. Moreover, if the first capacitance and the second capacitance are different from each other and the amount of a change in the first capacitance is greater than or equal to the prescribed value, the control circuit 5 determines that moisture be on the lens 103, and the control circuit 5 performs the second operation. Here, saying that “the first capacitance and the second capacitance are equal to each other” includes not only the case where the first capacitance and the second capacitance are exactly equal to each other but also the case where the difference between the first capacitance and the second capacitance is smaller than the specified value. Moreover, saying that “the first capacitance and the second capacitance are different from each other” refers to the case where the difference between the first capacitance and the second capacitance is greater than or equal to the specified value.

The first switch 54 includes the common terminal 540 and two selection terminals 541 and 542. The common terminal 540 is connected to the connection terminal 511. Moreover, the common terminal 540 is connected to the first connection terminal 61 via the connection terminal 511. The selection terminal 541 is not connected to any circuit. The selection terminal 542 is connected to a positive-side output terminal of the direct-current power supply 7. In the first switch 54, the common terminal 540 is connected to the selection terminal 541 in the first operation (see FIG. 4) and is connected to the selection terminal 542 in the second operation (see FIG. 5).

The second switch 55 includes the common terminal 550 and two selection terminals 551 and 552. The common terminal 550 is connected to the connection terminal 512. Moreover, the common terminal 550 is connected the second connection terminal 62 via the connection terminal 512. The selection terminal 551 is connected to the positive-side output terminal of the direct-current power supply 7. The selection terminal 552 is connected to the detection circuit 52. In the second switch 55, the common terminal 550 is connected to the selection terminal 552 in the first operation (see FIG. 4) and is connected to the selection terminal 551 in the second operation (see FIG. 5).

The third switch 56 includes the common terminal 560 and two selection terminal 561 and 562. The common terminal 560 is connected to the connection terminal 513. Moreover, the common terminal 560 is connected to the third connection terminal 63 via the connection terminal 513. The selection terminal 561 is not connected to any circuit. The selection terminal 562 is connected to the negative-side output terminal of the direct-current power supply 7. In the third switch 56, the common terminal 560 is connected to the selection terminal 561 in the first operation (see FIG. 4) and is connected to the selection terminal 562 in the second operation (see FIG. 5).

### (2.6) Connection Terminal

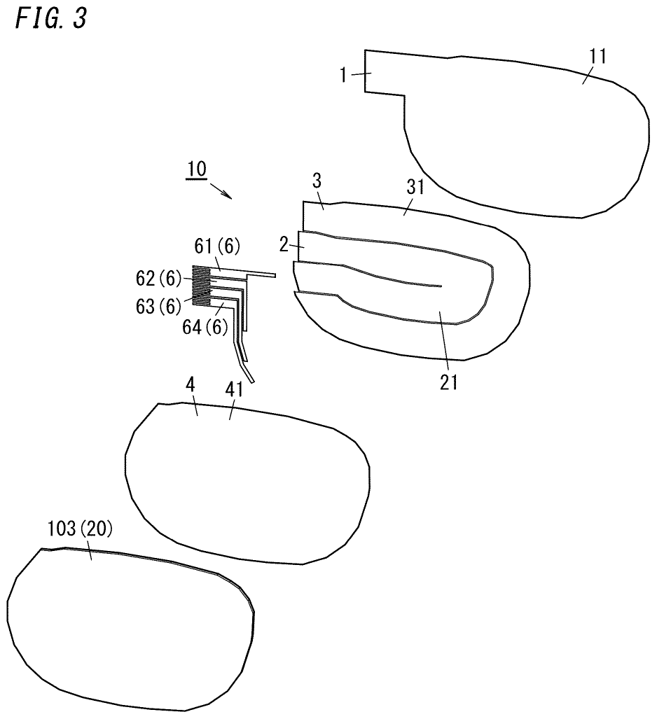

As shown in FIGS. 2 and 3, a plurality of connection terminals 6 include the first connection terminal 61, the second connection terminal 62, the third connection terminal 63, and the fourth connection terminal 64.

As shown in FIG. 2, the first connection terminal 61 is connected to a first end of the second electrode 3. Moreover, the first connection terminal 61 is connected to the connection terminal 511 of the control circuit 5.

As shown in FIG. 2, the second connection terminal 62 is connected to a first end of the first electrode 2. Moreover, the second connection terminal 62 is connected to the connection terminal 512 of the control circuit 5.

As shown in FIG. 2, the third connection terminal 63 is connected to a second end of the first electrode 2. Moreover, the third connection terminal 63 is connected to the connection terminal 513 of the control circuit 5.

As shown in FIG. 2, the fourth connection terminal 64 is connected to a second end of the second electrode 3. Moreover, the fourth connection terminal 64 is connected to the connection terminal 514 of the control circuit 5.

As described above, the plurality of connection terminals 6 are terminals for connecting the first electrode 2 and the second electrode 3 to the control circuit 5. That is, the control circuit 5 is connected to the first electrode 2 and the second electrode 3 via the plurality of connection terminals 6. Note that a connection terminal may be shared by the electrodes.

### (3) Moisture Removal Method

Next, the moisture removal method according to the first embodiment will be described with reference to FIGS. 4 to 6.

The moisture removal method according to the first embodiment is a moisture removal method used for the moisture removal system 10 described above. The moisture removal method includes a first step and a second step. The first step is a step of detecting capacitance between the first electrode 2 and the second electrode 3 by the control circuit 5. The second step is a step of energizing at least one electrode of the first electrode 2 or the second electrode 3 by the control circuit 5 to generate Joule heat at the at least one electrode. The first step corresponds to the first operation described above, and the second step corresponds to the second operation described above.

In the moisture removal method according to the first embodiment, the control circuit 5 detects the capacitance between the first electrode 2 and the second electrode 3 in the first step. Therefore, in the moisture removal method according to the first embodiment, capacitive coupling to a portion which is other than the moisture removal system 10 does not have to be formed. Moreover, in the moisture removal method according to the first embodiment, the control circuit 5 generates Joule heat at at least one of the first electrode 2 or the second electrode 3 in the second step. Therefore, in the moisture removal method according to the first embodiment, the object 20 can be heated, and as a result, moisture adhering to the object 20 can be removed. That is, the moisture removal method according to the first embodiment enables moisture to be detected without forming the capacitive coupling to the portion other than the moisture removal system 10 and enables the moisture adhering to the object 20, including the moisture removal system 10, to be removed.

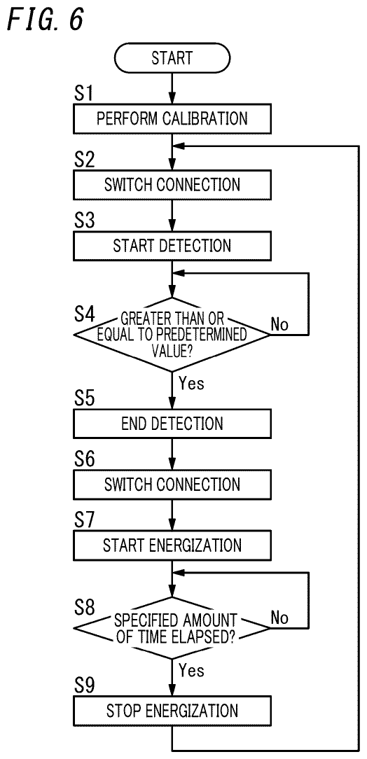

FIG. 6 is a flowchart of the moisture removal method according to the first embodiment. The moisture removal method according to the first embodiment includes SI to S9 shown in FIG. 6. Note that the flowchart shown in FIG. 6 is a mere example, and the order of the steps may accordingly be changed, or any of the steps may be omitted. The moisture removal method according to the first embodiment will be described below with reference to FIGS. 4 to 6.

First of all, the control circuit 5 performs calibration (step S1). Specifically, the control circuit 5 detects the capacitance, which can be the reference value in the first operation, between the first electrode 2 and the second electrode 3. At this time, the switching circuit 53 of the control circuit 5 connects the common terminal 540 of the first switch 54 to the selection terminal 541, connects the common terminal 550 of the second switch 55 to the selection terminal 552, and connects the common terminal 560 of the third switch 56 to the selection terminal 561 as shown in FIG. 4. Thus, the detection voltage is applied between the first electrode 2 and the second electrode 3 such that the first electrode 2 has the first potential and the second electrode 3 has the second potential.

Next, the control circuit 5 switches the connection state of the first switch 54, the second switch 55, and the third switch 56 to perform the first operation (step S2). In the example shown in FIG. 6, in order to perform calibration in step SI, the common terminal 540 of the first switch 54 is connected to the selection terminal 541, the common terminal 550 of the second switch 55 is connected to the selection terminal 552, and the common terminal 560 of the third switch 56 is connected to the selection terminal 561. Therefore, the control circuit 5 maintains the connection state of the first switch 54, the second switch 55, and the third switch 56 in step S2. Thus, the first electrode 2 as a detection electrode for detecting the capacitance is connected to the detection circuit 52.

Then, the control circuit 5 starts the first operation of detecting the capacitance between the first electrode 2 and the second electrode 3 (step S3). At this time, the control circuit 5 applies the detection voltage between the first electrode 2 and the second electrode 3 such that the first electrode 2 has the first potential and the second electrode 3 has the second potential (here, ground potential). The control circuit 5 determines whether or not the amount of change in the capacitance detected in the first operation (the amount of change in the capacitance with respect to the reference value described above) is greater than or equal to the prescribed value (step S4). If the amount of change in the capacitance detected in the first operation is less than the prescribed value (step S4: No), the control circuit 5 performs the first operation intermittently (e.g., every one second). That is, the control circuit 5 intermittently performs the first operation until moisture adhering to the object 20, including the moisture removal system 10, is detected. If the amount of change in the capacitance detected in the first operation is greater than or equal to a prescribed value (step S4: Yes), the control circuit 5 ends the first operation (step S5). In step S4, a threshold capacitance value stored in advance, for example, in the control circuit 5 may be set, and the capacitance detected in step S3 during the execution of step S4 may be compared with the threshold capacitance value, thereby determining whether or not the moisture is present. Here, the threshold capacitance value may be a typical value when no moisture is present or may be a typical value when the moisture is present.

Next, the control circuit 5 switches the connection state of the first switch 54, the second switch 55, and the third switch 56 to perform the second operation (step S6). Specifically, the control circuit 5 connects the common terminal 540 of the first switch 54 to the selection terminal 542, connects the common terminal 550 of the second switch 55 to the selection terminal 551, and connects the common terminal 560 of the third switch 56 to the selection terminal 562 as shown in FIG. 5. In the second operation, the direct-current power supply 7 is connected to the first electrode 2 and the second electrode 3, and energization of the first electrode 2 and the second electrode 3 is started (step S7). Thus, the first electrode 2 and the second electrode 3 generates Joule heat. That is, the first electrode 2 and the second electrode 3 function as a heater for heating the lens 103.

The control circuit 5 determines whether or not a specified amount of time (e.g., one minute) has elapsed (step S8). If the specified amount of time has not elapsed (step S8: No), the control circuit 5 maintains the energization of the first electrode 2 and the second electrode 3. If the specified amount of time has elapsed (step SS: Yes), the control circuit 5 stops the energization of the first electrode 2 and the second electrode 3 (step S9).

The control circuit 5 repeats steps S2 to S9 until moisture adhering to the object is removed. That is, when the control circuit 5 detects moisture, the control circuit 5 alternately performs the first operation and the second operation until the moisture is removed. Meanwhile, when the moisture adhering to the object has been removed, the control circuit 5 intermittently performs the first operation as described above.

Here, a weight assigned to the first electrode 2 and a weight assigned to the second electrode 3 may be different from each other in terms of at least one of an energization time period or the number of energization in the second operation. When the objects 20 are the lenses 103 of the pair of glasses 100 as in the first embodiment, the first electrodes 2 face the eyes of a user of the pair of glasses 100 in a state where the pair of glasses 100 are worn by the user. Therefore, the first electrode 2 is preferably weighted higher than the second electrode 3. For example, the energization time period of the first electrode 2 is set to be longer than the energization time period of the second electrode 3, or the number of energization of the first electrode 2 per unit time is set to be larger than the number of energization of the second electrode 3. For example, when the energization time period of the first electrode 2 is set to be longer than the energization time period of the second electrode 3, a time period during which the common terminal 540 of the first switch 54 is connected to the selection terminal 542 is set to be longer than a time period during which the common terminal 550 of the second switch 55 is connected to the selection terminal 551. Moreover, when the number of energization of the first electrode 2 is set to be larger than the number of energization of the second electrode 3, the number of times the common terminal 540 of the first switch 54 is connected to the selection terminal 542 is set to be larger than the number of times the common terminal 550 of the second switch 55 is connected to the selection terminal 551. This enables moisture adhering to a portion of the lens 103 corresponding to the first electrode 2 to be removed earlier than moisture adhering to a portion of the lens 103 corresponding to the second electrode 3.

In the moisture removal method according to the first embodiment, step S3 to S5 correspond to the first step, and step S7 to S9 correspond to the second step.

### (4) Effects

In the moisture removal system 10 according to the first embodiment, the control circuit 5 detects the capacitance between the first electrode 2 and the second electrode 3 in the first operation. Therefore, in the moisture removal system 10 according to the first embodiment, capacitive coupling to a portion which is other than the moisture removal system 10 does not have to be formed. Moreover, in the moisture removal system 10 according to the first embodiment, the control circuit 5 generates Joule heat at at least one of the first electrode 2 or the second electrode 3 in the second operation. Therefore, in the moisture removal system 10 according to the first embodiment, the object 20 can be heated, and as a result, moisture adhering to the object 20 can be removed. That is, the moisture removal system 10 according to the first embodiment enables moisture to be detected and adhering moisture to be removed without forming the capacitive coupling to a portion other than the moisture removal system 10.

Moreover, in the moisture removal system 10 according to the first embodiment, the control circuit 5 performs the second operation when an amount of change in the capacitance detected in the first operation is greater than or equal to a prescribed value. Thus, energy saving can be achieved as compared with the case where the second operation is always performed.

Moreover, in the moisture removal system 10 according to the first embodiment, the control circuit 5 applies the detection voltage between the first electrode 2 and the second electrode 3 in the first operation such that the first electrode 2 has the first potential and the second electrode 3 has the second potential. This enables a change in the capacitance caused due to the moisture to be detected. In particular, when the second potential is the ground potential, the amount of change in the capacitance is greater than when the second potential is higher than the ground potential, and thus, the detection accuracy of moisture can be improved.

Moreover, in the moisture removal system 10 according to the first embodiment, the control circuit 5 determines, in accordance with the result of comparison between the first capacitance and the second capacitance, whether or not the second operation is to be performed. Thus, an erroneous detection resulting from, for example, a finger can be reduced.

Moreover, in the moisture removal system 10 according to the first embodiment, each of the first electrode 2 and the second electrode 3 includes indium tin oxide. Thus, the object 20 can be heated, and an electromagnetic wave at a specific frequency is allowed to be transmitted.

Moreover, in the moisture removal system 10 according to the first embodiment, the control circuit 5 intermittently performs the first operation until moisture is detected, and once the control circuit 5 has detected the moisture, the control circuit 5 alternately performs the first operation and the second operation until the moisture is removed. Thus, the second operation is performed depending on a detection state of the moisture, and therefore, energy saving can be achieved as compared with the case where the second operation is always performed.

Moreover, in the moisture removal system 10 according to the first embodiment, the weight assigned to the first electrode 2 and the weight assigned to the second electrode 3 are different from each other in terms of at least one of an energization time period or the number of energization in the second operation. Thus, for example, highly weighting a portion to which moisture is more likely to adhere enables the moisture to be appropriately removed.

### (5) Variations

The first embodiment is merely an example of various embodiments of the present disclosure. The first embodiment may be modified variously depending on design or the like as long as the object of the present disclosure is achieved. Moreover, a function similar to the moisture removal system 10 according to the first embodiment may be implemented by, for example, the moisture removal method described above, a (computer) program, or a non-transitory recording medium storing the program. A program according to an aspect is a program configured to cause one or more processors to execute the moisture removal method described above. This program enables moisture to be detected and adhering moisture to be removed without forming the capacitive coupling to a portion other than the moisture removal system 10.

Variations of the first embodiment will be enumerated below. Any of the variations to be described below may be combined as appropriate.

### (5.1) First Variation

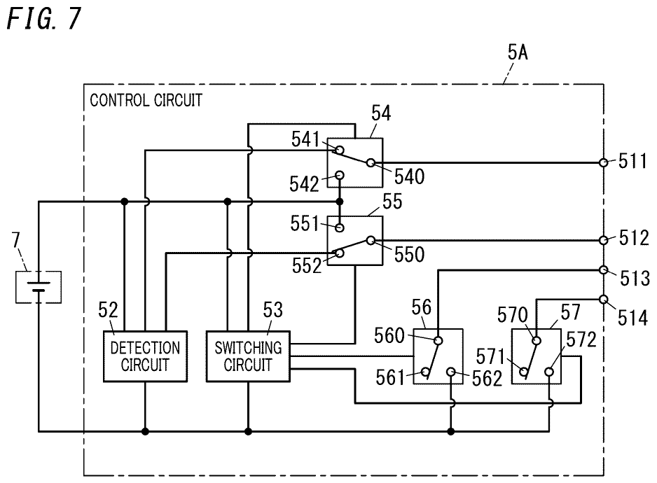

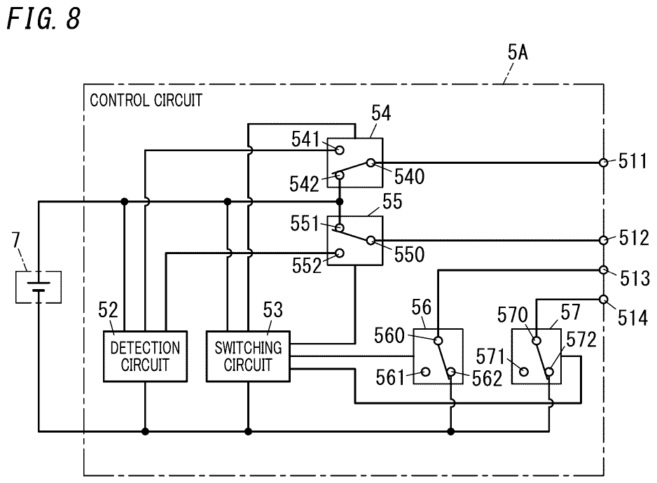

In the first embodiment, the detection method by the detection circuit 52 is a self method. However, the detection method by the detection circuit 52 may be a mutual method. With reference to FIGS. 7 and 8, a moisture removal system 10 according to the first variation will be described below. In the moisture removal system 10 according to the first variation, components similar to those in the moisture removal system 10 according to the first embodiment are denoted by the same reference signs as those in the first embodiment, and the description thereof will be omitted.

### (5.1.1) Configuration

The moisture removal system 10 according to the first variation further includes a base member 1, a first electrode 2, a second electrode 3, a protective layer 4, a control circuit 5A, and a plurality of connection terminals 6.

As shown in FIGS. 7 and 8, the control circuit 5A includes a plurality of (in the example shown in the figure, four) connection terminals 511 to 514, a detection circuit 52, a switching circuit 53, a first switch 54, a second switch 55, and a third switch 56. Moreover, the control circuit 5A further includes a fourth switch 57.

The first switch 54 includes the common terminal 540 and two selection terminals 541 and 542. The common terminal 540 is connected to the connection terminal 511. Moreover, the common terminal 540 is connected to the first connection terminal 61 via the connection terminal 511. The selection terminal 541 is connected to the detection circuit 52. The selection terminal 542 is connected to a positive-side output terminal of the direct-current power supply 7.

The second switch 55 includes the common terminal 550 and two selection terminals 551 and 552. The common terminal 550 is connected to the connection terminal 512. Moreover, the common terminal 550 is connected the second connection terminal 62 via the connection terminal 512. The selection terminal 551 is connected to the positive-side output terminal of the direct-current power supply 7. The selection terminal 552 is connected to the detection circuit 52.

The third switch 56 includes a common terminal 560 and two selection terminal 561 and 562. The common terminal 560 is connected to the connection terminal 513. Moreover, the common terminal 560 is connected to the third connection terminal 63 via the connection terminal 513. The selection terminal 561 is not connected to any circuit. The selection terminal 562 is connected to the negative-side output terminal of the direct-current power supply 7.

The fourth switch 57 includes a common terminal 570 and two selection terminals 571 and 572. The common terminal 570 is connected to the connection terminal 514. Moreover, the common terminal 570 is connected to a fourth connection terminal 64 via the connection terminal 514. The selection terminal 571 is not connected to any circuit. The selection terminal 572 is connected to the negative-side output terminal of the direct-current power supply 7.

### (5.1.2) Moisture Removal Method

The moisture removal method according to the first variation includes a first step and a second step. The first step is a step of detecting capacitance between the first electrode 2 and the second electrode 3 by the control circuit 5A. The second step is a step of energizing at least one electrode of the first electrode 2 or the second electrode 3 by the control circuit 5A to generate Joule heat at the at least one electrode. In the first variation, the control circuit 5A energizes both the first electrode 2 and the second electrode 3 in the second step, thereby generating Joule heat at both the first electrode 2 and the second electrode 3.

As shown in FIG. 7, the control circuit 5A connects the common terminal 540 of the first switch 54 to the selection terminal 541 and connects the common terminal 550 of the second switch 55 to the selection terminal 552 in the first step. Moreover, the control circuit 5A connects the common terminal 560 of the third switch 56 to the selection terminal 561 and connects the common terminal 570 of the fourth switch 57 to the selection terminal 571 in the first step. Thus, both the first electrode 2 and the second electrode 3 are connected to the detection circuit 52, and the detection circuit 52 detects the capacitance between the first electrode 2 and the second electrode 3.

If the amount of change in the capacitance detected in the first step is greater than or equal to a prescribed value, the control circuit 5A executes the second step. As shown in FIG. 8, the control circuit 5A connects the common terminal 540 of the first switch 54 to the selection terminal 542 and connects the common terminal 550 of the second switch 55 to the selection terminal 551 in the second step. Moreover, the control circuit 5A connects the common terminal 560 of the third switch 56 to the selection terminal 562 and connects the common terminal 570 of the fourth switch 57 to the selection terminal 572 in the second step. Thus, both the first electrode 2 and the second electrode 3 are connected to the direct-current power supply 7, and energization of both the first electrode 2 and the second electrode 3 is started. As a result, Joule heat is generated at each of the first electrode 2 and the second electrode 3, and the Joule heat heats lenses 103 (objects 20), thereby removing moisture adhering to the lenses 103.

### (5.1.3) Effects

In a similar manner to the moisture removal system 10 according to the first embodiment, the moisture removal system 10 according to the first variation enables moisture to be detected and adhering moisture to be removed without forming the capacitive coupling to a portion other than the moisture removal system 10.

### (5.2) Other Variations

Other variations are enumerated below.

The moisture removal system 10 or an agent that carries out the moisture removal method in the present disclosure includes a computer system. The computer system may include a processor and a memory as principal hardware components thereof. The processor executes a program stored in the memory of the computer system, thereby implementing the function as the moisture removal system 10 or the agent that carries out the moisture removal method in the present disclosure. The program may be stored in advance in the memory of the computer system. Alternatively, the program may also be downloaded over a telecommunications network or be distributed after having been recorded in some non-transitory storage medium such as a memory card, an optical disc, or a hard disk drive, any of which is readable for the computer system. The processor of the computer system includes one or more electronic circuits including a semiconductor integrated circuit (IC) or a large scale integrated circuit (LSI). As used herein, the “integrated circuit” such as an IC or an LSI is called by a different name depending on the degree of integration thereof. Examples of the integrated circuits include a system LSI, a very-large-scale integrated circuit (VLSI), and an ultra-large-scale integrated circuit (ULSI). Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be integrated together in a single device or distributed in multiple devices without limitation. As used herein, the “computer system” includes a microcontroller including one or more processors and one or more memory elements. Therefore, the microcontroller also includes one or more electronic circuits including a semiconductor integrated circuit or a large scale integrated circuit.

Also, in the embodiment described above, the plurality of functions of the moisture removal system 10 are aggregated together in a single housing. However, this is not an essential configuration for the moisture removal system 10. Alternatively, the components of the moisture removal system 10 may be distributed in a plurality of different housings. Still alternatively, at least some functions of the moisture removal system 10, for example, some functions of the control circuit 5, may be implemented as a cloud computing system as well.

In the first embodiment, the control circuit 5 generates Joule heat at both the first electrode 2 and the second electrode 3 in the second operation. However, the control circuit 5 may generate Joule heat only, for example, at the first electrode 2, or may generate Joule heat only at the second electrode 3. That is, the control circuit 5 may energize at least one electrode of the first electrode 2 or the second electrode 3 in the second operation to generate Joule heat at the one electrode.

In the first embodiment, each of the first electrode 2 and the second electrode 3 includes indium tin oxide. However, each of the first electrode 2 and the second electrode 3 may include, for example, a transparent conductive polymer. The transparent conductive polymer is, for example, a 3,4-ethylene dioxythiophene resin. Note that the transparent conductive polymer is not limited to the 3,4-ethylene dioxythiophene resin.

In the first embodiment, the second potential is the ground potential. However, the second potential is not limited to the ground potential as long as it is lower than the first potential. Moreover, in the first embodiment, the third potential is equal to the first potential, but the third potential may be higher than the first potential, and further, the third potential has a value greater than the second potential and is at least a potential which provides a difference enabling the first capacitance value attributed to moisture and the second capacitance value attributed to contact of a finger to be distinguished from each other.

In the first embodiment, the first electrode 2 is used as a detection electrode for detecting the capacitance, and the second electrode is used as the ground electrode. In contrast, after the first electrode 2 is used as the detection electrode and the second electrode 3 is used as the ground electrode, the second electrode 3 may be used as the detection electrode and the first electrode 2 may be used as the ground electrode. That is, after the control circuit 5, 5A applies a detection voltage between the first electrode 2 and the second electrode 3 such that the first electrode 2 has the first potential and the second electrode 3 has the second potential lower than the first potential in the first operation, the control circuit 5, 5A applies the detection voltage between the first electrode 2 and the second electrode 3 such that the first electrode 2 has the second potential and the second electrode 3 has the first potential. The second potential is, for example, a ground potential. Thus, the detection accuracy can be improved.

In the first embodiment, the base member 1 and the lenses 103 are separate components. However, it goes without saying that the base member I configured to have a lens function can provide a similar effect.

In the first embodiment, the part of the human body is a finger. However, the part of the human body is not limited to the finger but may be, for example, an elbow or a knee. Of course, the part may be any part other than the finger, elbow, or knee as long as it is a part of the human body.

### Second Embodiment

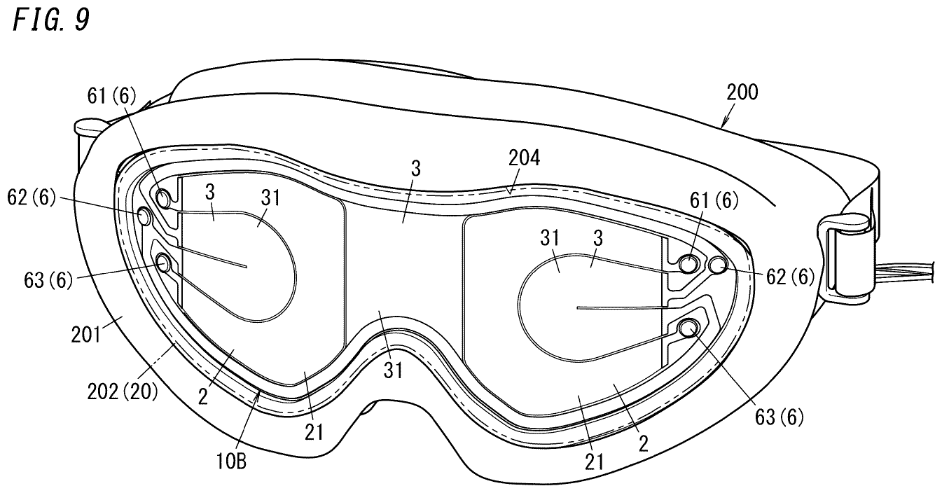

With reference to FIGS. 9 to 12, a moisture removal system 10B according to a second embodiment will be described. In the moisture removal system 10B according to the second embodiment, components similar to those in the moisture removal system 10 according to the first embodiment are denoted by the same reference signs as those in the first embodiment, and the description thereof will be omitted.

The moisture removal system 10B according to the second embodiment is different from the moisture removal system 10 according to the first embodiment in that the moisture removal system 10B includes a plurality of first electrodes 2. Moreover, the moisture removal system 10B according to the second embodiment is different from the moisture removal system 10 according to the first embodiment in that the moisture removal system 10B includes a plurality of second electrodes 3.

### (1) Configurations

First of all, the configuration of the moisture removal system 10B according to the second embodiment will be described with reference to FIGS. 9 to 12.

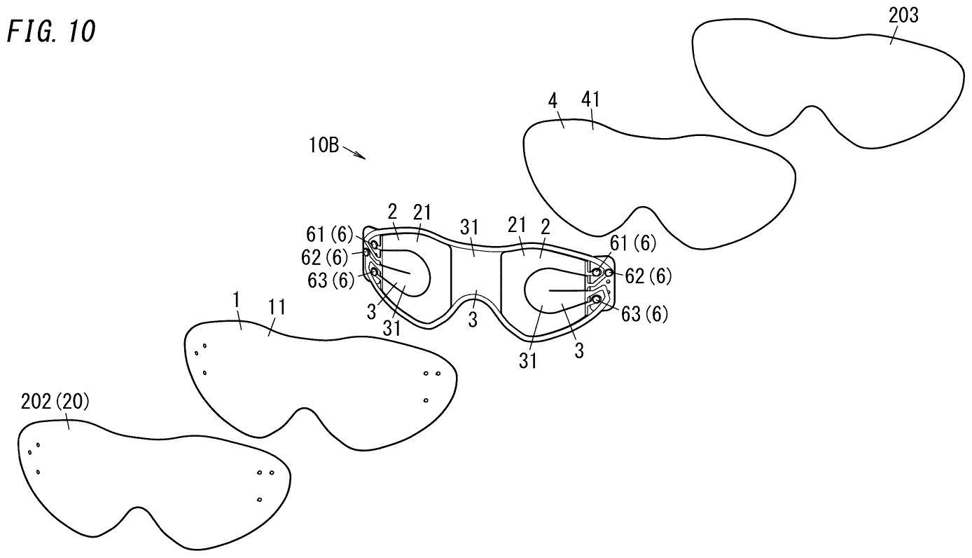

As shown in FIG. 9, the moisture removal system 10B according to the second embodiment is attached to goggles 200 and removes moisture adhering to a first lens 202 of the goggles 200. That is, in the second embodiment, the first lens 202 of the goggles 200 is the object 20. The goggles 200 include a goggles body 201, the first lens 202, and a second lens 203 (see FIG. 10). As shown in FIG. 9, the goggles body 201 has an opening 204. The opening 204 has an elliptical shape along a longitudinal direction of the goggles body 201 (left/right direction in FIG. 9). The first lens 202 and the second lens 203 are fitted in the opening 204 such that the first lens 202 is located forward of the second lens 203, i.e., the second lens 203 is located backward of the first lens 202.

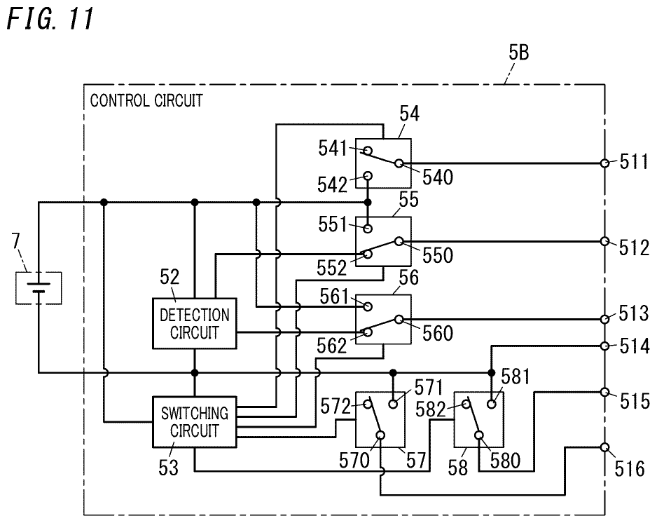

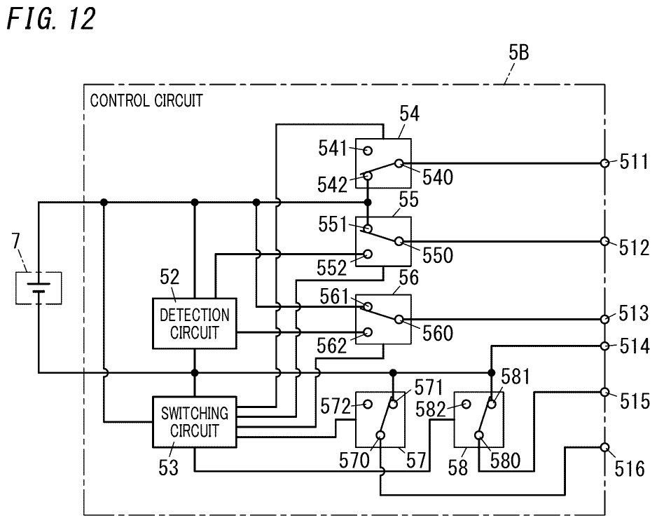

As shown in FIG. 10, the moisture removal system 10B according to the second embodiment includes a base member 1, a plurality of (in the example shown in the figure, two) first electrodes 2, a plurality of (in the example shown in the figure, three) second electrodes 3, a protective layer 4, a control circuit 5B (see FIGS. 11 and 12), and a plurality of (in the example shown in the figure, six) connection terminals 6.

### (1.1) Base Member

In a similar manner to the first embodiment, the base member 1 is, for example, a transparent film. The base member 1 has a size substantially equal to, for example, the size of the first lens 202 in plan view in a thickness direction defined with respect to the base member 1.

### (1.2) First Electrode and Second Electrode

The two first electrodes 2 are disposed on the base member 1, on both sides in the longitudinal direction of the base member 1. Two second electrodes 3 of the three second electrodes 3 are disposed on the base member 1, on both sides in the longitudinal direction of the base member 1. Moreover, each of the two first electrodes 2 is disposed to surround a corresponding one of the two second electrodes 3. Further, the remaining one second electrode 3 of the three second electrodes 3 is disposed on the base member 1, between the two first electrodes 2.

### (1.3) Protective Layer

In a similar manner to the first embodiment, the protective layer 4 is, for example, an OCA. The protective layer 4 has a size substantially equal to, for example, the size of the base member 1 in plan view in a thickness direction as defined with respect to the protective layer 4.

### (1.4) Control Circuit

As shown in FIGS. 11 and 12, the control circuit 5B includes a plurality of (in the example shown in the figure, six) connection terminals 511 to 516, a detection circuit 52, a switching circuit 53, a first switch 54, a second switch 55, a third switch 56, a fourth switch 57, and a fifth switch 58.

The first switch 54 includes a common terminal 540 and a plurality of (in the example shown in the figure, two) selection terminals 541 and 542. The common terminal 540 is connected to the connection terminal 511. Moreover, the common terminal 540 is connected to one second connection terminal 62 (on the right side in FIG. 9) via the connection terminal 511. The selection terminal 541 is not connected to any circuit. The selection terminal 542 is connected to a positive-side output terminal of a direct-current power supply 7.

The second switch 55 includes a common terminal 550 and a plurality of (in the example shown in the figure, two) selection terminals 551 and 552. The common terminal 550 is connected to the connection terminal 512. Moreover, the common terminal 550 is connected to one first connection terminal 61 (on the right side in FIG. 9) via the connection terminal 512. The selection terminal 551 is connected to the positive-side output terminal of the direct-current power supply 7. The selection terminal 552 is connected to the detection circuit 52.

The third switch 56 includes a common terminal 560 and a plurality of (in the example shown in the figure, two) selection terminals 561 and 562. The common terminal 560 is connected to the connection terminal 513. Moreover, the common terminal 560 is connected to the other first connection terminal 61 (on the left in FIG. 9) via the connection terminal 513. The selection terminal 561 is connected to the positive-side output terminal of the direct-current power supply 7. The selection terminal 562 is connected to the detection circuit 52.

The fourth switch 57 includes a common terminal 570 and a plurality of (in the example shown in the figure, two) selection terminals 571 and 572. The common terminal 570 is connected to the connection terminal 516. Moreover, the common terminal 570 is connected to one third connection terminal 63 (on the right side in FIG. 9) via the connection terminal 516. The selection terminal 571 is connected to a negative-side output terminal of the direct-current power supply 7. The selection terminal 572 is not connected to any circuit.

The fifth switch 58 includes a common terminal 580 and a plurality of (in the example shown in the figure, two) selection terminals 581 and 582. The common terminal 580 is connected to the connection terminal 515. Moreover, the common terminal 580 is connected to the other third connection terminal 63 (on the left side in FIG. 9) via the connection terminal 515. The selection terminal 581 is connected to the negative-side output terminal of the direct-current power supply 7. The selection terminal 582 is not connected to any circuit.

### (1.5) Connection Terminal

The plurality of connection terminals 6 include the plurality of (in the example shown in the figure, two) first connection terminals 61, the plurality of (in the example shown in the figure, two) second connection terminals 62, and the plurality of (in the example shown in the figure, two) third connection terminals 63.

The one first connection terminal 61 (on the right side in FIG. 9) of the two first connection terminals 61 is connected to a first end of one first electrode 2 (on the right side in FIG. 9) of the two first electrodes 2. Moreover, the one first connection terminal 61 is connected to the connection terminal 512 of the control circuit 5B. The other first connection terminal 61 (on the left side in FIG. 9) of the two first connection terminals 61 is connected to a first end of the other first electrode 2 (on the left side in FIG. 9) of the two first electrodes 2. Moreover, the other first connection terminal 61 is connected to the connection terminal 513 of the control circuit 5B.

The one second connection terminal 62 (on the right side in FIG. 9) of the two second connection terminals 62 is connected to a first end of each of the two second electrodes 3 of the three second electrodes 3 disposed on both sides in the longitudinal direction of the base member 1. Moreover, the one second connection terminal 62 is connected to the connection terminal 511 of the control circuit 5B. The other second connection terminal 62 (on the left side in FIG. 9) of the two second connection terminals 62 is connected to a second end of each of the two second electrodes 3 of the three second electrodes 3 disposed on both the sides in the longitudinal direction of the base member 1. Moreover, the other second connection terminal 62 is connected to the connection terminal 514 of the control circuit 5B.

The one third connection terminal 63 (on the right side in FIG. 9) of the two third connection terminals 63 is connected to a second end of the one first electrode 2 (on the right side in FIG. 9) of the two first electrodes 2. Moreover, the one third connection terminal 63 is connected to the connection terminal 516 of the control circuit 5B. The other third connection terminal 63 (on the left side in FIG. 9) of the two third connection terminals 63 is connected to a second end of the other first electrode 2 (on the left side in FIG. 9) of the two first electrodes 2. Moreover, the other third connection terminal 63 is connected to the connection terminal 515 of the control circuit 5B.

### (2) Moisture Removal Method

Next, a moisture removal method according to the second embodiment will be described with reference to FIGS. 11 and 12.

The moisture removal method according to the second embodiment includes a first step and a second step. The first step is a step of detecting capacitance between the first electrode 2 and the second electrode 3 by the control circuit 5B. The second step is a step of energizing at least one electrode of the first electrode 2 or the second electrode 3 by the control circuit 5B to generate Joule heat at the at least one electrode. In the second embodiment, the control circuit 5B energizes both the first electrode 2 and the second electrode 3 in the second step, thereby generating Joule heat at both the first electrode 2 and the second electrode 3.

As shown in FIG. 11, the control circuit 5B connects the common terminal 540 of the first switch 54 to the selection terminal 541, connects the common terminal 550 of the second switch 55 to the selection terminal 552, and connects the common terminal 560 of the third switch 56 to the selection terminal 562 in the first step. Moreover, the control circuit 5B connects the common terminal 570 of the fourth switch 57 to the selection terminal 572 and connects the common terminal 580 of the fifth switch 58 to the selection terminal 582 in the first step. Thus, the two first electrodes 2 are connected to the detection circuit 52, and the three second electrodes 3 are connected to the negative-side output terminal of the direct-current power supply 7. Thus, the potential of each of the three second electrodes 3 is the ground potential.

If the amount of change in the capacitance detected in the first step is greater than or equal to a prescribed value, the control circuit 5B executes the second step. As shown in FIG. 12, the control circuit 5B connects the common terminal 540 of the first switch 54 to the selection terminal 542, connects the common terminal 550 of the second switch 55 to the selection terminal 551, and connects the common terminal 560 of the third switch 56 to the selection terminal 561 in the second step. Moreover, the control circuit 5B connects the common terminal 570 of the fourth switch 57 to the selection terminal 571 and connects the common terminal 580 of the fifth switch 58 to the selection terminal 581 in the second step. Thus, the two first electrodes 2 and the three second electrodes 3 are connected to the direct-current power supply 7, and the energization of the two first electrodes 2 and the three second electrodes 3 is started. As a result, the Joule heat is generated at each of the two first electrodes 2 and the three second electrodes 3, and the Joule heat heats the first lens 202, thereby removing moisture adhering to the first lens 202.

In the second embodiment, the detection method by the detection circuit 52 is a self method. However, the detection method by the detection circuit 52 is not limited to the self method but may be, for example, a mutual method.

Moreover, in the second embodiment, the first lens 202 is the object 20, but, for example, the second lens 203 may be the object, or both the first lens 202 and the second lens 203 may be the objects.

### (3) Effects

In a similar manner to the moisture removal system 10 according to the first embodiment, the moisture removal system 10B according to the second embodiment enables moisture to be detected and adhering moisture to be removed without forming the capacitive coupling to a portion other than the moisture removal system 10B.

In the second embodiment, the base member 1 and the first lens 202 are separate components. However, it goes without saying that the first lens 202 configured to have the function of the base member 1 can provide a similar effect.

Note that various configurations described in the second embodiment may be employed accordingly in combination with various configurations (including the variations) described in the first embodiment.

### Third Embodiment

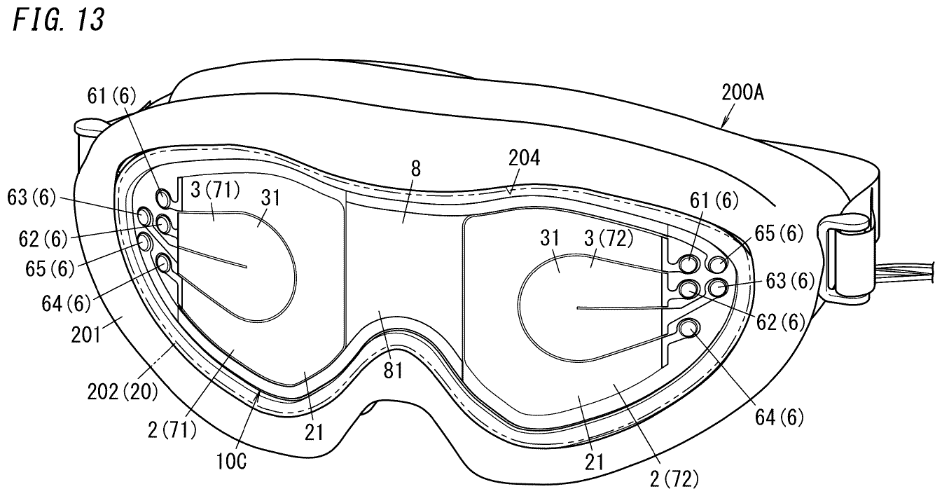

With reference to FIG. 13, a moisture removal system 10C according to a third embodiment will be described. In the moisture removal system 10C according to the third embodiment, components similar to those in the moisture removal system 10B according to the second embodiment are denoted by the same reference signs as those in the second embodiment, and the description thereof will be omitted.

The moisture removal system 10C according to the third embodiment is different from the moisture removal system 10B according to the second embodiment in that the moisture removal system 10C includes two second electrodes 3. Moreover, the moisture removal system 10C according to the third embodiment is different from the moisture removal system 10B according to the second embodiment in that the moisture removal system 10C includes a third electrode 8.

### (1) Configurations

First of all, the moisture removal system 10C according to the third embodiment will be described with reference to FIG. 13.

As shown in FIG. 13, the moisture removal system 10° C. according to the third embodiment is attached to goggles 200 and removes moisture adhering to a first lens 202 of the goggles 200. That is, in the third embodiment, the first lens 202 of the goggles 200 is the object 20. The goggles 200 include a goggles body 201, the first lens 202, and a second lens 203. As shown in FIG. 13, the goggles body 201 has an opening 204. The opening 204 has an elliptical shape along a longitudinal direction of the goggles body 201 (left/right direction in FIG. 13). The first lens 202 and the second lens 203 are fitted in the opening 204 such that the first lens 202 is located forward of the second lens 203, i.e., the second lens 203 is located backward of the first lens 202.

As shown in FIG. 13, the moisture removal system 10C according to the third embodiment includes a base member 1, a plurality of (in the example shown in the figure, two) first electrodes 2, the plurality of (in the example shown in the figure, two) second electrodes 3, a protective layer 4, and a control circuit 5B. That is, the moisture removal system 10C according to the third embodiment includes two first electrodes 2 and two second electrodes 3. Moreover, the moisture removal system 10C further includes the third electrode 8. Moreover, the moisture removal system 10C includes a plurality of (in the example shown in the figure, ten) connection terminals 6.

### (1.1) Base Member

In a similar manner to the first embodiment, the base member 1 is, for example, a transparent film. The base member 1 has a size substantially equal to, for example, the size of the first lens 202 in plan view in a thickness direction defined with respect to the base member 1.

### (1.2) First Electrode, Second Electrode, and Third Electrode

The two first electrodes 2 are disposed on the base member 1, on both sides in the longitudinal direction of the base member 1. The two second electrodes 3 are disposed on the base member 1, on both sides in the longitudinal direction of the base member 1. Moreover, each of the two first electrodes 2 is disposed to surround a corresponding one of the two second electrodes 3.

In the following description, a group of one first electrode 2 (on the left side in FIG. 13) of the two first electrodes 2 and one second electrode 3 (on the left side in FIG. 13) of the two second electrodes 3 is referred to as a first electrode group 71. Moreover, a group of the other first electrode 2 (on the right side in FIG. 13) of the two first electrodes 2 and the other second electrode 3 (on the right side in FIG. 13) of the two second electrodes 3 is referred to as a second electrode group 72.

In a similar manner to the first electrodes 2 and the second electrodes 3, the third electrode 8 includes, for example, indium tin oxide. The third electrode 8 has, for example, a rectangular shape in plan view in a thickness direction as defined with respect to the third electrode 8. The third electrode 8 has a fifth transmission part 81 capable of transmitting an electromagnetic wave at a specific frequency. The electromagnetic wave at the specific frequency is, for example, visible light ranging from 405 to 790 THz as described above. Moreover, the third electrode 8 includes indium tin oxide as described above. Thus, in the third embodiment, the entirety of the third electrode 8 is the fifth transmission part 81. As shown in FIG. 13, the third electrode 8 is disposed on the base member 1 such that the fifth transmission part 81 overlaps a first transmission part 11. Moreover, the third electrode 8 is disposed on the base member 1, between the first electrode group 71 and the second electrode group 72.

### (1.3) Protective Layer

In a similar manner to the first embodiment, the protective layer 4 is, for example, an OCA. The protective layer 4 has a size substantially equal to, for example, the size of the base member 1 in plan view in a thickness direction as defined with respect to the protective layer 4.

### (2) Moisture Removal Method

Next, a moisture removal method according to the third embodiment will be described.

The moisture removal method according to the third embodiment includes a first step and a second step. The first step is a step of detecting capacitance between the first electrode 2 and the second electrode 3 in each of the electrode groups 71 and 72 by the control circuit 5B. The second step is a step of energizing at least one electrode of the first electrodes 2, the second electrodes 3, or the third electrode 8 by the control circuit 5B to generate Joule heat at the one electrode. In the third embodiment, the control circuit 5B energizes all of the first electrodes 2, the second electrodes 3, and the third electrode 8 in the second step, thereby generating Joule heat at all the first electrodes 2, the second electrodes 3, and the third electrode 8.

The control circuit 5B applies a detection voltage to each of the first electrode group 71 and the second electrode group 72 in the first step. More specifically, the control circuit 5B applies the detection voltage between the first electrode 2 and the second electrode 3 such that the first electrode 2 has the first potential and the second electrode 3 has the second potential in the first step. In a similar manner to the first embodiment, the second potential is a ground potential.

If the amount of change in the capacitance detected in the first step is greater than or equal to a prescribed value, the control circuit 5B executes the second step. The control circuit 5B alternately switches between a first state where the first electrode group 71 and the third electrode S are energized and a second state where the second electrode group 72 and the third electrode 8 are energized in the second step (second operation). In the first state, Joule heat is generated at the first electrode 2 and the second electrode 3 of the first electrode group 71 and the third electrode 8, and the Joule heat heats the center and a right side of the first lens 202 of the goggles 200. Moreover, in the second state, Joule heat is generated at the first electrode 2 and the second electrode 3 of the second electrode group 72 and the third electrode 8, and the Joule heat heats the center and a left side of the first lens 202 of the goggles 200. As a result, moisture adhering to the first lens 202 (object 20) can be removed. In the third embodiment, the control circuit 5B switches between the energized states of the third electrode 8 in accordance with the sensing result in the first operation as described above.

A detection method by the detection circuit 52 may be a self method or may be a mutual method.

The third electrode 8 is not limited to functioning as a heater electrode but may be, for example, always connected to ground.

### (3) Effects

In a similar manner to the moisture removal system 10 according to the first embodiment, the moisture removal system 10C according to the third embodiment enables moisture to be detected and adhering moisture to be removed without forming the capacitive coupling to a portion other than the moisture removal system 10C.

The third embodiment includes two groups each including a combination of the first electrode 2 and the second electrode 3. However, one combination of the first electrode 2 and the second electrode 3, or three or more combinations each including the first electrode 2 and the second electrode 3 may be provided. Moreover, the third embodiment includes one third electrode 8, but the number of the third electrode 8 is not limited to one. Two or more third electrodes 8 may be provided.

In the third embodiment, the base member 1 and the first lens 202 are separate components. However, it goes without saying that the first lens 202 configured to have the function of the base member I can provide a similar effect.

Note that various configurations described in the third embodiment may be employed accordingly in combination with various configurations (including the variations) described in the first and second embodiments.

### Fourth Embodiment

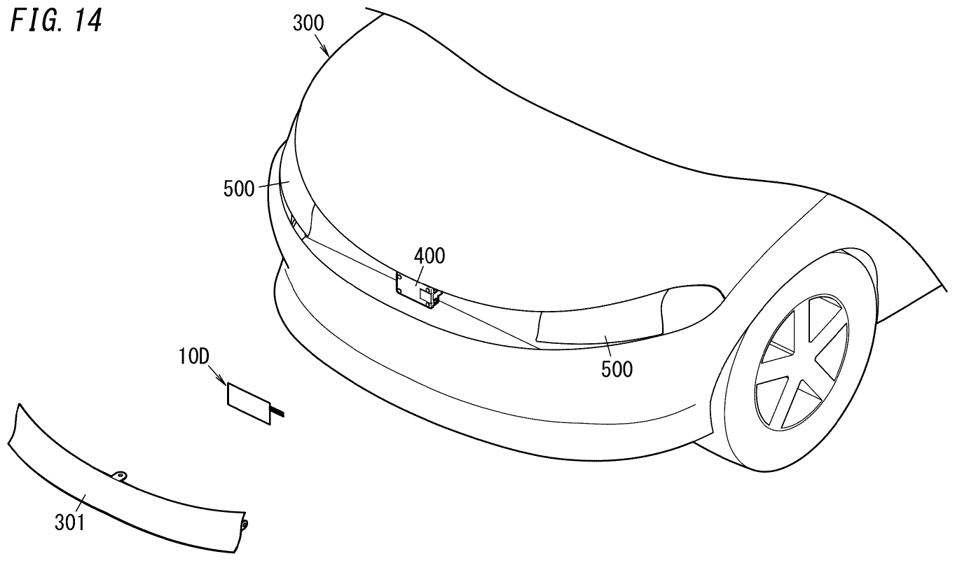

With reference to FIGS. 14 to 17, a moisture removal system 10D according to a fourth embodiment will be described. In the moisture removal system 10D according to the fourth embodiment, components similar to those in the moisture removal system 10 according to the first embodiment are denoted by the same reference signs as those in the first embodiment, and the description thereof will be omitted.

The moisture removal system 10D according to the fourth embodiment is different from the moisture removal system 10 according to the first embodiment in that the object 20 is a radome 301 of an automobile 300.

### (1) Configurations

As shown in FIG. 14, the moisture removal system 10D according to the fourth embodiment is attached to the radome 301 of the automobile 300 and removes moisture adhering to the radome 301. That is, in the fourth embodiment, the radome 301 of the automobile 300 is the object 20. The radome 301 is attached to the automobile 300 to cover a detection device 400 disposed on the front of the automobile 300. The detection device 400 is, for example, a millimetric-wave radar. The detection device 400 outputs an electromagnetic wave (millimetric wave) having a frequency higher than or equal to 30 GHZ and lower than or equal to 300 GHZ. That is, the radome 301 is capable of transmitting an electromagnetic wave (millimetric wave) at a specific frequency (here a frequency higher than or equal to 30 GHz and lower than or equal to 300 GHZ).

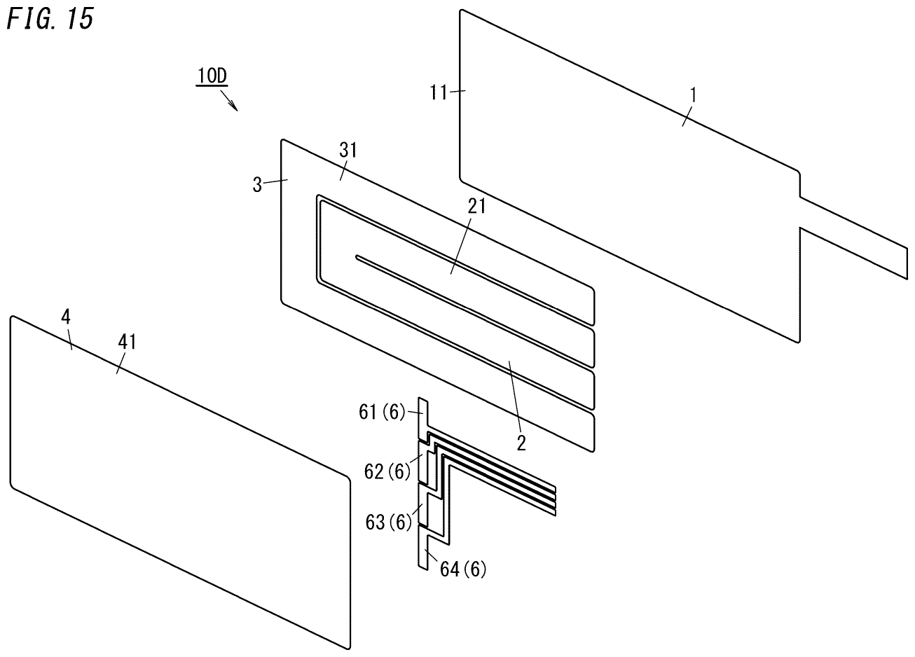

As shown in FIG. 15, the moisture removal system 10D according to the fourth embodiment includes a base member 1, a first electrode 2, a second electrode 3, a protective layer 4, a control circuit 5, and a plurality of (in the example shown in the figure, four) connection terminals 6.

### (1.1) Base Member

In a similar manner to the first embodiment, the base member 1 is, for example, a film capable of transmitting an electromagnetic wave. The base member I has a rectangular shape in plan view in a thickness direction defined with respect to the base member 1 and has a size substantially equal to the size of the millimetric-wave radar described above.

### (1.2) First Electrode and Second Electrode

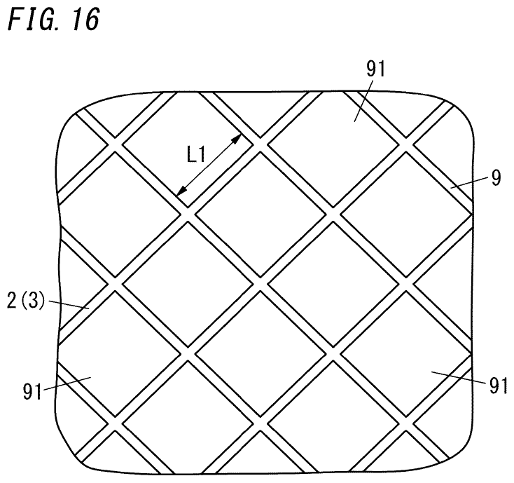

As shown in FIG. 16, the first electrode 2 is a metal body 9 having, for example, a plurality of openings 91. The metal body 9 is, for example, a plated copper wire. The copper wire preferably has a surface laminated with a blackened layer. That is, the first electrode 2 includes a metal material. The opening shape of each of the plurality of openings 91 is, for example, a rectangular shape. A minimum value L1 of an opening dimension of each of the plurality of openings 91 is preferably greater than or equal to ½λ, where λ is the wavelength of an electromagnetic wave transmitted through the opening 91.

In a similar manner to the first electrode 2, the second electrode 3 is a metal body 9 having, for example, a plurality of openings 91. The metal body 9 is, for example, a plated copper wire. The copper wire preferably has a surface laminated with a blackened layer. That is, the first electrode 2 includes a metal material. The opening shape of each of the plurality of openings 91 is, for example, a rectangular shape. A minimum value L1 of an opening dimension of each of the plurality of openings 91 is preferably greater than or equal to ½λ, where λ is the wavelength of an electromagnetic wave transmitted through the opening 91.

In the fourth embodiment, the electromagnetic wave transmitted through the openings 91 is a millimetric wave. The wavelength λ of the millimetric wave is longer than or equal to 1 mm and shorter than or equal to 10 mm. Thus, the minimum value L1 of the opening dimension of the opening 91 is preferably greater than or equal to ½λ, that is, greater than or equal to 500 μm (0.5 mm). The minimum value L1 of the opening dimension of the opening 91 is more preferably greater than or equal to 1000 μm (1 mm), much more preferably greater than or equal to 1500 μm (1.5 mm). This allows transmission of the electromagnetic wave (millimetric wave) output from the detection device 400.

### (1.3) Protective Layer

In a similar manner to the first embodiment, the protective layer 4 is an OCA. The protective layer 4 has a rectangular shape and has a size substantially equal to, for example, the size of the base member 1 in plan view in a thickness direction as defined with respect to the protective layer 4.

### (1.4) Connection Terminal

The plurality of connection terminals 6 include a first connection terminal 61, a second connection terminal 62, a third connection terminal 63, and a fourth connection terminal 64.

The first connection terminal 61 is connected to a first end of the second electrode 3. The second connection terminal 62 is connected to a first end of the first electrode 2. The third connection terminal 63 is connected to a second end of the first electrode 2. the fourth connection terminal 64 is connected to a second end of the second electrode 3. Moreover, the first connection terminal 61, the second connection terminal 62, the third connection terminal 63, and the fourth connection terminal 64 are connected to the control circuit 5.

(2) Effects In a similar manner to the moisture removal system 10 according to the first embodiment, the moisture removal system 10D according to the fourth embodiment enables moisture to be detected and adhering moisture to be removed without forming the capacitive coupling to a portion other than the moisture removal system 10D.

### (3) Variations

(3.1) First Variation

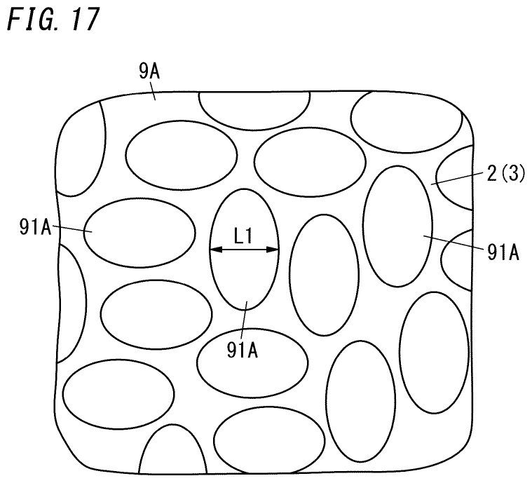

In the fourth embodiment, the opening shape of each of the plurality of openings 91 in the metal body 9 is the rectangular shape. In contrast, for example, the opening shape of each of a plurality of openings 91A in a metal body 9A may be an elliptical shape as shown in FIG. 17.

As shown in FIG. 17, each of a first electrode 2 and a second electrode 3 is the metal body 9A having the plurality of openings 91A. The opening shape of each of the plurality of openings 91A is, for example, the elliptical shape. A minimum value LI of the opening dimension of each opening 91A is the short diameter (length of the minor axis) of the ellipse forming the opening 91A. The minimum value LI of the opening dimension of each opening 91A is preferably 1/2%, where A is the wavelength of an electromagnetic wave transmitted through the opening 91A. This allows the electromagnetic wave to be radiated through the plurality of opening 91A in the metal body 9A to the outside.
(3.2) Second Variation

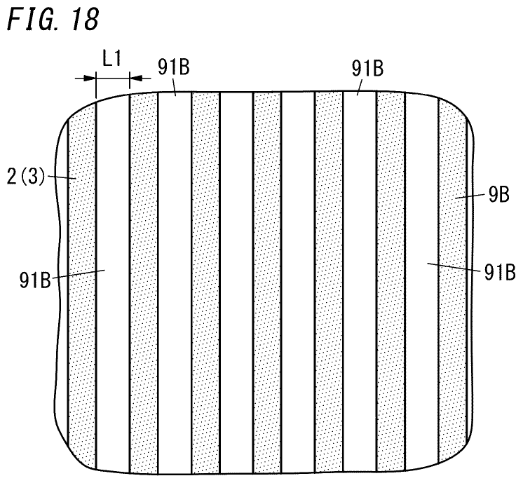

In the fourth embodiment, each of the first electrode 2 and the second electrode 3 has a mesh shape having the plurality of openings 91. In contrast, for example, each of a first electrode 2 and a second electrode 3 may be a metal body 9B having a plurality of openings 91B as shown in FIG. 18. Note that in FIG. 18, conductor portions of the metal body 9B are shaded with dots so that the conductor portions are easily distinguished from the openings 91B, but the shading do not represent a cross section.

As shown in FIG. 18, each of the first electrode 2 and the second electrode 3 are the metal body 9B having the plurality of openings 91B. The opening shape of each of the plurality of openings 91B is a rectangular shape which is more elongated in a second direction (up/down direction in FIG. 18) than in a first direction (left/right direction in FIG. 18). That is, each of the plurality of openings 91B is a slit formed along the second direction. The plurality of openings 91B are aligned at equal intervals in the first direction.

Here, a minimum value L1 of the opening dimension (space distance) of each opening 91B is the dimension along the first direction as shown in FIG. 17. The minimum value LI of the opening dimension of each opening 91B is preferably greater than or equal to ½λ, where λ is the wavelength of the electromagnetic wave (millimetric wave). In the second variation, the electromagnetic wave is a millimetric wave (electromagnetic wave having a wavelength longer than or equal to 1 mm and shorter than or equal to 10 mm), and therefore, the minimum value LI is preferably greater than or equal to 500 μm. Meanwhile, in the second variation, the opening dimension in the second direction is satisfactorily large with respect to the opening dimension in the first direction, which allows the millimetric wave (electromagnetic wave) to be transmitted even when the minimum value L1 is less than 500 μm. Specifically, the minimum value L1 may be, for example, 100 μm, 200 μm, 300 μm, or 400 μm. Note that in the second variation, the width dimension (dimension in the first direction) of each conductor portion in the metal body 9B is, for example, 6 μm.

In the fourth embodiment, the base member 1 and the radome 301 are separate components. However, it goes without saying that the radome 301 configure to have the function of the base member 1 can provide a similar effect.

Note that various configurations described in the fourth embodiment may be employed accordingly in combination with various configurations (including the variations) described in the first to third embodiments.

### Fifth Embodiment

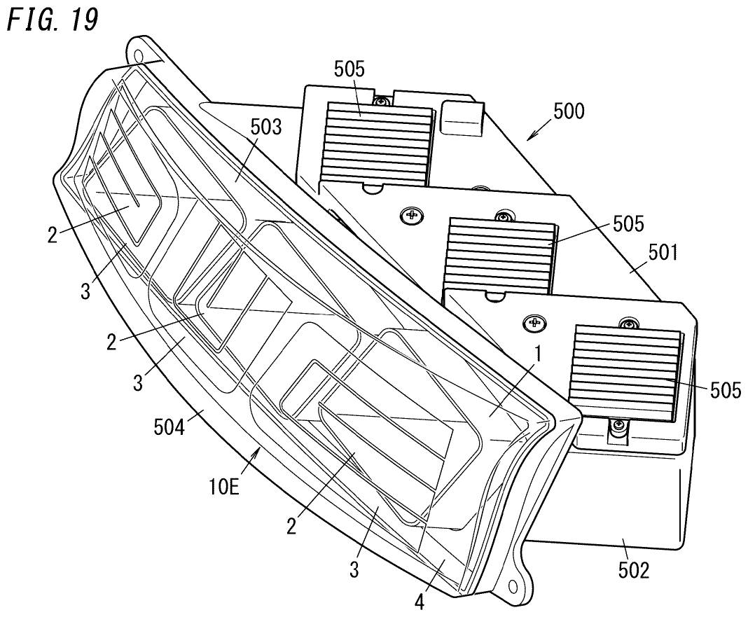

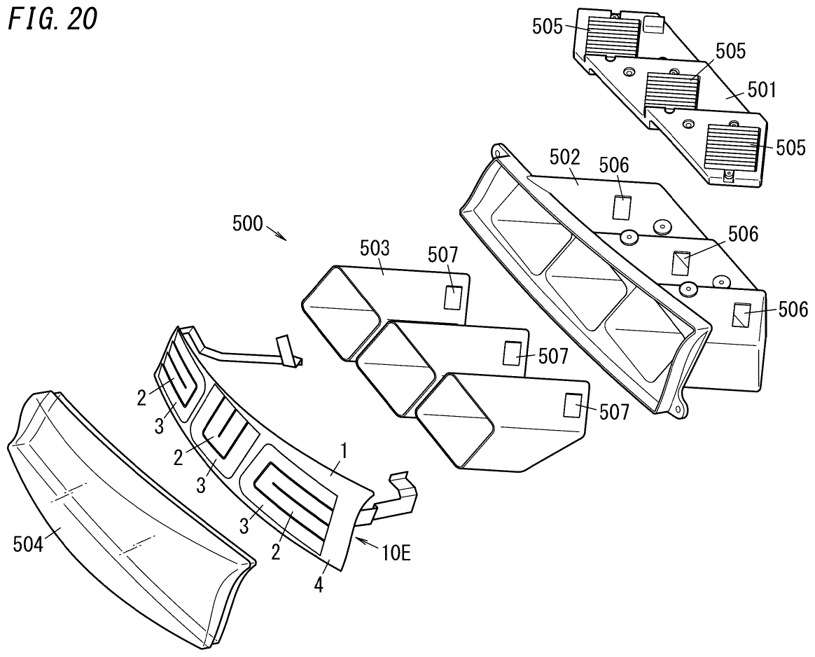

With reference to FIGS. 19 and 20, a moisture removal system 10E according to a fifth embodiment will be described. In the moisture removal system 10E according to the fifth embodiment, components similar to those in the moisture removal system 10 according to the first embodiment are denoted by the same reference signs as those in the first embodiment, and the description thereof will be omitted.

The moisture removal system 10E according to the fifth embodiment is different from the moisture removal system 10 according to the first embodiment in that the object 20 is a cover lens 504 of a headlight 500.

### (1) Configurations

The moisture removal system 10E according to the fifth embodiment is a system for removing moisture adhering to the cover lens 504 of the headlight 500 attached to the automobile 300 (see FIG. 14). The moisture removal system 10E is attached to the cover lens 504. That is, in the fifth embodiment, the cover lens 504 of the headlight 500 is the object 20.

As shown in FIGS. 19 and 20, the headlight 500 includes a light source unit 501, a housing 502, a reflector 503, and the cover lens 504. The light source unit 501 includes a plurality of (in the example shown in the figure, three) light sources 505. Each of the plurality of light sources 505 includes one or more Light-Emitting Diodes (LEDs). The housing 502 has a plurality of openings 506. The plurality of openings 506 correspond to the plurality of light sources 505 on a one-to-one basis. The reflector 503 has a plurality of openings 507. The plurality of openings 507 correspond to the plurality of openings 506 on a one-to-one basis. A material for the cover lens 504 is, for example, polycarbonate (PC).

When the headlight 500 is assembled, each of the plurality of openings 506 overlaps a corresponding opening 507 of the plurality of openings 507. Moreover, when the headlight 500 is assembled, the one or more LEDs in each of the plurality of light sources 505 face opposing openings 506 of the plurality of openings 506. Light radiated from the one or more LEDs in each light source 505 passes through corresponding ones of the openings 506 and 507, is incident on the reflector 503, is reflected off an inner surface of the reflector 503, and is then radiated toward the cover lens 504.

As shown in FIGS. 19 and 20, the moisture removal system 10E includes a base member 1, a plurality of (in the example shown in the figure, three) first electrodes 2, a plurality of (in the example shown in the figure, three) second electrodes 3, a protective layer 4, a control circuit 5, and a plurality of connection terminals 6.

### (1.1) Base Member

In a similar manner to the first embodiment, the base member 1 is a transparent film. The base member 1 has a rectangular shape in plan view in a thickness direction defined with respect to the base member 1 and has a substantially same size as the one surface (front surface) of the cover lens 504.

### (1.2) First Electrode

In a similar manner to the first embodiment, each of the plurality of first electrodes 2 includes, for example, indium tin oxide. Each first electrode 2 has, for example, a U-shape in plan view in a thickness direction defined with respect to the first electrode 2. The plurality of first electrodes 2 are arranged along a longitudinal direction (left/right direction in FIG. 19) of the base member 1.

### (1.3) Second Electrode

Each of the plurality of second electrodes 3 includes, for example, indium tin oxide in a similar manner to the first electrode 2. Each second electrode 3 has, for example, a U-shape in plan view in a thickness direction defined with respect to the second electrode 3. The plurality of second electrodes 3 are arranged along a longitudinal direction (left/right direction in FIG. 19) of the base member 1. Moreover, each of the plurality of second electrodes 3 is disposed to surround a corresponding one of the plurality of first electrodes 2.

### (1.4) Protective Layer

In a similar manner to the first embodiment, the protective layer 4 is, for example, an OCA. The protective layer 4 has a rectangular shape and has a size substantially equal to, for example, the size of the base member I in plan view in a thickness direction as defined with respect to the protective layer 4.

### (2) Moisture Removal Method

Next, a moisture removal method according to the fifth embodiment will be described. In the following description, a first electrode 2 and a second electrode 3 corresponding to each other are defined as one electrode group. That is, the moisture removal system 10E according to the fifth embodiment includes three electrode groups.

The moisture removal method according to the fifth embodiment includes a first step and a second step. The first step is a step of detecting capacitance between the first electrode 2 and the second electrode 3 in each electrode group by the control circuit 5. The second step is a step of energizing at least one electrode of the first electrode 2 or the second electrode 3 in each electrode group by the control circuit 5 to generate Joule heat at the one electrode in each electrode group. In the fifth embodiment, the control circuit 5 energizes both the first electrode 2 and the second electrode 3 in each electrode group in the second step, thereby generating Joule heat at both the first electrode 2 and the second electrode 3 in each electrode group.

The control circuit 5 applies a detection voltage between the first electrode 2 and the second electrode 3 in each electrode group in the first step. More specifically, the control circuit 5 applies the detection voltage between the first electrode 2 and the second electrode 3 in each electrode group such that the first electrode 2 has the first potential and the second electrode 3 has the second potential. In a similar manner to the first embodiment, the second potential is a ground potential.

If the amount of change in the capacitance detected in the first step is greater than or equal to a prescribed value, the control circuit 5 executes the second step. The control circuit 5 energizes both the first electrode 2 and the second electrode 3 in an electrode group which is included in the plurality of electrode groups and in which the amount of change in the capacitance is greater than or equal to the prescribed value in the second step (second operation), thereby generating Joule heat at both the first electrode 2 and the second electrode 3 in the electrode group. As a result, moisture adhering to a portion which is part of the cover lens 504 and which faces the electrode group can be removed.

A detection method by the detection circuit 52 of the control circuit 5 may be a self method or may be a mutual method.

Moreover, in a second step (second operation), energizing both the first electrode 2 and the second electrode 3 in each electrode group is not required, but at least one electrode of the first electrode 2 or the second electrode 3 may be energized.

### (3) Effects

In a similar manner to the moisture removal system 10 according to the first embodiment, the moisture removal system 10E according to the fifth embodiment enables moisture to be detected and adhering moisture to be removed without forming the capacitive coupling to a portion other than the moisture removal system 10E.

In the fifth embodiment, the base member 1 and the cover lens 504 are separate components. However, it goes without saying that the cover lens 504 configured to have the function of the base member 1 can provide a similar effect.

Note that various configurations described in the fifth embodiment may be employed accordingly in combination with various configurations (including the variations) described in the first to fourth embodiments.

### Aspects

The present specification discloses the following aspects.

A moisture removal system (10; 10B to 10E) of a first aspect is a moisture removal system (10; 10B to 10E) configured to be attached to an object (20) and to remove adhering moisture. The moisture removal system (10; 10B to 10E) includes a base member (1) which is electrically insulating, a first electrode (2), a second electrode (3), and a control circuit (5; 5A; 5B). The base member (1) has a first transmission part (11) capable of transmitting an electromagnetic wave. The first electrode (2) has a second transmission part (21) capable of transmitting the electromagnetic wave and is disposed on the base member (1) such that the second transmission part (21) overlaps the first transmission part (11). The second electrode (3) has a third transmission part (31) capable of transmitting the electromagnetic wave and is disposed on the base member (1) such that the third transmission part (31) overlaps the first transmission part (11). The control circuit (5; 5A; 5B) is connected to the first electrode (2) and the second electrode (3). The control circuit (5; 5A; 5B) is configured to perform first operation and second operation. The first operation is operation of detecting capacitance between the first electrode (2) and the second electrode (3). The second operation is operation of energizing at least one electrode of the first electrode (2) or the second electrode (3) to generate Joule heat at the at least one electrode.

In this aspect, the control circuit (5; 5A; 5B) detects the capacitance between the first electrode (2) and the second electrode (3) in the first operation. Therefore, this aspect requires no capacitive coupling to a portion other than the moisture removal system (10; 10B to 10E). Moreover, in this aspect, the control circuit (5; 5A; 5B) causes Joule heat to be generated at at least one of the first electrode (2) or the second electrode (3) in the second operation. Therefore, this aspect enables the object (20) to be heated and consequently enables moisture adhering to the moisture removal system (10; 10B to 10E) itself and the object (20) to be removed. That is, with this aspect, the moisture adhering to the moisture removal system (10; 10B to 10E) itself and the object (20) can be detected and removed without forming the capacitive coupling to the portion other than the moisture removal system (10; 10B to 10E).

In a moisture removal system (10; 10B to 10E) of a second aspect referring to the first aspect, the control circuit (5; 5A; 5B) is configured to perform the second operation when an amount of change in the capacitance detected in the first operation is greater than or equal to a prescribed value.

In this aspect, the second operation is performed when an amount of change in the capacitance detected in the first operation is greater than or equal to a prescribed value. Therefore, this aspect enables energy to be saved as compared with the case where the second operation is always performed.

In a moisture removal system (10; 10B to 10E) of a third aspect referring to any one of the first or second aspect, the control circuit (5; 5A; 5B) is configured to apply a detection voltage between the first electrode (2) and the second electrode (3) in the first operation such that the first electrode (2) has a first potential and the second electrode (3) has a second potential. The second potential is lower than the first potential.

This aspect enables a change in the capacitance caused due to the moisture to be detected.

In a moisture removal system (10; 10B to 10E) of a fourth aspect referring to the third aspect, the second potential is a ground potential.

With this aspect, the amount of change in the capacitance is large as compared with the case where the second potential is higher than the ground potential, and therefore, the detection accuracy of moisture can be improved.

In a moisture removal system (10; 10B to 10E) of a fifth aspect referring to any one of the first to third aspects, the control circuit (5; 5A; 5B) is configured to compare first capacitance and second capacitance with each other to determine, in accordance with a comparison result, whether or not to perform the second operation. The first capacitance is capacitance detected when a first detection voltage is applied between the first electrode (2) and the second electrode (3) such that the first electrode (2) has a first potential and the second electrode (3) has a second potential. The second capacitance is capacitance detected when a second detection voltage is applied between the first electrode (2) and the second electrode (3) such that the first electrode (2) has the first potential and the second electrode (3) has a third potential. The second potential is lower than the first potential. The third potential has a value greater than the second potential and is a potential difference providing a capacitance difference based on which a first capacitance value attributed to moisture and a second capacitance value attributed to contact of a part of a human body are distinguishable from each other,

With this aspect, an erroneous detection due to, for example, a finger can be reduced.

In a moisture removal system (10; 10B to 10E) of a sixth aspect referring to the fifth aspect, the second potential is a ground potential.

With this aspect, the amount of change in the capacitance is large as compared with the case where the second potential is higher than the ground potential, and therefore, the detection accuracy of moisture can be improved.

In a moisture removal system (10; 10B to 10E) of a seventh aspect referring to the fifth aspect, the third potential is a potential higher than or equal to the first potential.

With this aspect, a capacitance difference between when the part of the human body is in contact and when the water droplet is detected is large, and as a result, the detection accuracy can be improved.

In a moisture removal system (10; 10B to 10E) of an eighth aspect referring to any one of the fifth to seventh aspects, the control circuit (5: 5A; 5B) is configured to perform the second operation when the first capacitance and the second capacitance are different from each other.

With this aspect, erroneous operation due to contact of part (e.g., a finger) of the human body can be reduced.

In a moisture removal system (10) of a ninth aspect referring to any one of the first to eighth aspects, the control circuit (5) is configured to apply a detection voltage between the first electrode (2) and the second electrode (3) such that the first electrode (2) has a first potential and the second electrode (3) has a second potential lower than the first potential and then apply the detection voltage between the first electrode (2) and the second electrode (3) such that the first electrode (2) has the second potential and the second electrode (3) has the first potential in the first operation.

With this aspect, the detection accuracy can be improved.

A moisture removal system (10C) of a tenth aspect referring to any one of the first to ninth aspects further includes at least one third electrode (8). The at least one third electrode (8) has a fifth transmission part (81) capable of transmitting the electromagnetic wave and is disposed on the base member (1) such that the fifth transmission part (81) overlaps the first transmission part (11). The control circuit (5B) is configured to switch between energized states of the at least one third electrode (8) in accordance with a sensing result in the first operation.

With this aspect, the at least one third electrode (8) is driven in accordance with the first operation, and thereby, water droplets can be efficiently removed.

In a moisture removal system (10; 10B to 10E) according to an eleventh aspect referring to any one of the first to tenth aspects, each of the first electrode (2) and the second electrode (3) includes a metal material.

With this aspect, the object (20) can be efficiently heated.

In a moisture removal system (10; 10B to 10E) of a twelfth aspect referring to any one of the first to tenth aspects, each of the first electrode (2) and the second electrode (3) includes indium tin oxide.

With this aspect, the object (20) can be heated, and the electromagnetic wave can be transmitted.

In a moisture removal system (10) of a thirteenth aspect referring to any one of the first to tenth aspects, each of the first electrode (2) and the second electrode (3) includes a transparent conductive polymer.

With this aspect, the object (20) can be heated, and the electromagnetic wave can be transmitted.

In a moisture removal system (10D) of a fourteenth aspect referring to any one of the first to tenth aspects, each of the first electrode (2) and the second electrode (3) is a metal body (9; 9A; 9B) having a plurality of openings (91; 91A; 91B).

With this aspect, the electromagnetic wave can be transmitted, and the object (20) can be heated.

In a moisture removal system (10D) of a fifteenth aspect referring to the fourteenth aspect, a minimum value (L1) of an opening dimension of each of the plurality of openings (91; 91A; 91B) is greater than or equal to ½λ, where λ is a wavelength of the electromagnetic wave transmitted through the plurality of openings (91; 91A; 91B).

With this aspect, the object (20) can be heated, and the electromagnetic wave at a specific wavelength can be transmitted.

In a moisture removal system (10; 10B to 10E) of a sixteenth aspect referring to any one of the first to fifteenth aspects, the control circuit (5; 5A; 5B) is configured to intermittently perform the first operation until the moisture is detected. The control circuit (5; 5A; 5B) is configured to, when the moisture is detected, alternately perform the first operation and the second operation until the control circuit (5; 5A; 5B) determines that the moisture has been removed from the object (20).

With this aspect, the second operation is performed depending on a detection state of the moisture, and therefore, energy saving can be achieved as compared with the case where the second operation is always performed.

In a moisture removal system (10; 10B to 10E) of a seventeenth aspect referring to any one of the first to sixteenth aspects, the control circuit (5; 5A; 5B) is configured to energize both the first electrode (2) and the second electrode (3) in the second operation. A weight assigned to the first electrode (2) and a weight assigned to the second electrode (3) are different from each other in terms of at least one of an energization time period or the number of energization in the second operation.

With this aspect, for example, highly weighting a portion to which moisture is more likely to adhere enables the moisture to be appropriately removed.

A moisture removal system (10; 10B to 10E) of an eighteenth aspect referring to any one of the first to seventeenth aspects further includes a protective layer (4) which is electrically insulating. The protective layer (4) has a fourth transmission part (41) capable of transmitting the electromagnetic wave. The protective layer (4) covers the first electrode (2) such that the fourth transmission part (41) overlaps the second transmission part (21), and the protective layer (4) covers the second electrode (3) such that the fourth transmission part (41) overlaps the third transmission part (31).

With this aspect, the protective layer (4) can protect the first electrode (2) and the second electrode (3).

A moisture removal method of a nineteenth aspect is a moisture removal method used for a moisture removal system (10; 10B to 10E) including a base member (1) having an electrically insulating property, a first electrode (2), a second electrode (3), and a control circuit (5; 5A; 5B) and which is to be attached to an object (20) to remove moisture. The base member (1) has a first transmission part (11) configured to be attached to the object (20) and capable of transmitting an electromagnetic wave. The first electrode (2) has a second transmission part (21) capable of transmitting the electromagnetic wave and is disposed on the base member (1) such that the second transmission part (21) overlaps the first transmission part (11). The second electrode (3) has a third transmission part (31) capable of transmitting the electromagnetic wave and is disposed on the base member (1) such that the third transmission part (31) overlaps the first transmission part (11). The control circuit (5; 5A; 5B) is connected to the first electrode (2) and the second electrode (3). The moisture removal method includes a first step and a second step. The first step is a step of detecting capacitance between the first electrode (2) and the second electrode (3) by the control circuit (5; 5A; 5B). The second step is a step of energizing at least one electrode of the first electrode (2) or the second electrode (3) by the control circuit (5; 5A; 5B) to generate Joule heat at the at least one electrode.

With this aspect, the control circuit (5; 5A; 5B) detects the capacitance between the first electrode (2) and the second electrode (3) in the first step. Therefore, this aspect requires no capacitive coupling to a portion other than the moisture removal system (10; 10B to 10E). Moreover, in this aspect, the control circuit (5; 5A; 5B) generates the Joule heat at at least one of the first electrode (2) or the second electrode (3) in the second step. Therefore, in this aspect, the object (20) can be heated, and as a result, moisture adhering to the object (20) can be removed. That is, this aspect enables moisture to be detected and the moisture adhering to the object (20), including the moisture removal system (10; 10B to 10E), to be removed without forming capacitive coupling to a portion other than the moisture removal system (10; 10B to 10E).

A program of a twentieth aspect is a program configured to cause one or more processors to execute the moisture removal method of the nineteenth aspect.

With this aspect, the control circuit (5; 5A; 5B) detects the capacitance between the first electrode (2) and the second electrode (3) in the first step. Therefore, this aspect requires no capacitive coupling to a portion other than the moisture removal system (10; 10B to 10E). Moreover, in this aspect, the control circuit (5; 5A; 5B) generates the Joule heat at at least one of the first electrode (2) or the second electrode (3) in the second step. Therefore, in this aspect, the object (20) can be heated, and as a result, moisture adhering to the object (20) can be removed. That is, this aspect enables moisture to be detected and the moisture adhering to the object (20), including the moisture removal system (10; 10B to 10E), to be removed without forming capacitive coupling to a portion other than the moisture removal system (10; 10B to 10E).

The configurations of the second to eighteenth aspects are not configurations essential for the moisture removal system (10; 10B to 10E) and may accordingly be omitted.

### REFERENCE SIGNS LIST

1 Base Member

2 First Electrode

3 Second Electrode

4 Protective Layer

8 Third Electrode

9, 9A, 9B Metal Body

10, 10B to 10E Moisture Removal System

11 First Transmission Part

20 Object

21 Second Transmission Part

31 Third Transmission Part

41 Fourth Transmission Part

71 First Electrode Group

72 Second Electrode Group

81 Fifth Transmission Part

91, 91A, 91B Opening

L1 Minimum Value

1. A moisture removal system configured to be attached to an object and to remove adhering moisture, the moisture removal system comprising:
a base member having a first transmission part capable of transmitting an electromagnetic wave, the base member being electrically insulating:
a first electrode having a second transmission part capable of transmitting the electromagnetic wave, the first electrode being disposed on the base member such that the second transmission part overlaps the first transmission part;
a second electrode having a third transmission part capable of transmitting the electromagnetic wave, the second electrode being disposed on the base member such that the third transmission part overlaps the first transmission part; and
a control circuit connected to the first electrode and the second electrode,
the control circuit being configured to perform
first operation of detecting capacitance between the first electrode and the second electrode and
second operation of energizing at least one electrode of the first electrode or the second electrode to generate Joule heat at the at least one electrode.

2. The moisture removal system of claim 1, wherein
the control circuit is configured to perform the second operation when an amount of change in the capacitance detected in the first operation is greater than or equal to a prescribed value.

3. The moisture removal system of claim 1, wherein
the control circuit is configured to apply a detection voltage between the first electrode and the second electrode in the first operation such that the first electrode has a first potential and the second electrode has a second potential lower than the first potential.

4. The moisture removal system of claim 3, wherein
the second potential is a ground potential.

15. The moisture removal system of claim 2, wherein
the control circuit is configured to compare first capacitance and second capacitance with each other to determine, in accordance with a comparison result, whether or not to perform the second operation,
the first capacitance being the capacitance detected when a first detection voltage is applied between the first electrode and the second electrode such that the first electrode has a first potential and the second electrode has a second potential lower than the first potential,
the second capacitance being capacitance detected when a second detection voltage is applied between the first electrode and the second electrode such that the first electrode has the first potential and the second electrode has a third potential,
the third potential having a value greater than the second potential and being a potential difference providing a capacitance difference based on which a first capacitance value attributed to moisture and a second capacitance value attributed to contact of a part of a human body are distinguishable from each other.

6. The moisture removal system of claim 5, wherein
the second potential is a ground potential.

7. The moisture removal system of claim 5, wherein
the third potential is a potential higher than or equal to the first potential.

8. The moisture removal system of claim 5, wherein
the control circuit is configured to perform the second operation when the first capacitance and the second capacitance are different from each other.

9. The moisture removal system of claim 1, wherein
the control circuit is configured to apply a detection voltage between the first electrode and the second electrode such that the first electrode has a first potential and the second electrode has a second potential lower than the first potential and then apply the detection voltage between the first electrode and the second electrode such that the first electrode has the second potential and the second electrode has the first potential in the first operation.

10. The moisture removal system of claim 1, further comprising at least one third electrode having a fifth transmission part capable of transmitting the electromagnetic wave, the at least one third electrode being disposed on the base member such that the fifth transmission part overlaps the first transmission part, wherein
the control circuit is configured to switch between energized states of the at least one third electrode in accordance with a sensing result in the first operation.

11. The moisture removal system of claim 1, wherein
each of the first electrode and the second electrode includes a metal material.

12. The moisture removal system of claim 1, wherein
each of the first electrode and the second electrode includes indium tin oxide.

13. The moisture removal system of claim 1, wherein
each of the first electrode and the second electrode includes a transparent conductive polymer.

14. The moisture removal system of claim 1, wherein
each of the first electrode and the second electrode is a metal body having a plurality of openings.

15. The moisture removal system of claim 14, wherein
a minimum value of an opening dimension of each of the plurality of openings is greater than or equal to ½λ, where λ is a wavelength of the electromagnetic wave transmitted through the plurality of openings.

16. The moisture removal system of claim 1, wherein
the control circuit is configured to
intermittently perform the first operation until the moisture is detected, and
when the moisture is detected, alternately perform the first operation and the second operation until the control circuit determines that the moisture has been removed from the object.

17. The moisture removal system of claim 2, wherein
the control circuit is configured to energize both the first electrode and the second electrode in the second operation, and
a weight assigned to the first electrode and a weight assigned to the second electrode are different from each other in terms of at least one of an energization time period or the number of energization in the second operation.

18. The moisture removal system of claim 1, further comprising a protective layer, wherein
the protective layer
has a fourth transmission part capable of transmitting the electromagnetic wave,
covers the first electrode such that the fourth transmission part overlaps the second transmission part,
covers the second electrode such that the fourth transmission part overlaps the third transmission part, and
is electrically insulating.

19. A moisture removal method used for a moisture removal system including
a base member configured to be attached to an object, having a first transmission part capable of transmitting an electromagnetic wave, and being electrically insulating,
a first electrode having a second transmission part capable of transmitting the electromagnetic wave, the first electrode being disposed on the base member such that the second transmission part overlaps the first transmission part,
a second electrode having a third transmission part capable of transmitting the electromagnetic wave, the second electrode being disposed on the base member such that the third transmission part overlaps the first transmission part, and
a control circuit connected to the first electrode and the second electrode,
the moisture removal system being configured to be attached to the object to remove moisture.
the moisture removal method comprising:
a first step of detecting capacitance between the first electrode and the second electrode by the control circuit; and
a second step of energizing at least one electrode of the first electrode or the second electrode by the control circuit to generate Joule heat at the at least one electrode.

20. A non-transitory computer-readable tangible storage medium storing a program configured to cause one or more processors to execute the moisture removal method of claim 19.
